(19) United States
(12) Patent Application Publication
(10) Pub. No.: US 2015/0111574 A1
(43) Pub. Date: Apr. 23, 2015

(54) RELAY DEVICE, WIRELESS TERMINAL DEVICE, COMMUNICATION SYSTEM AND COMMUNICATION METHOD

(71) Applicant: Sharp Kabushiki Kaisha, Osaka-shi, Osaka (JP)

(72) Inventors: Hidenobu Fukumasa, Osaka-shi (JP); Shusaku Fukumoto, Osaka-shi (JP); Toshiaki Kameno, Osaka-shi (JP); Shuichi Takehana, Osaka-shi (JP); Yuichi Nobusawa, Osaka-shi (JP)

(21) Appl. No.: 14/399,044

(22) PCT Filed: May 13, 2013
(86) PCT No.: PCT/JP2013/063259

§ 371 Date: Nov. 5, 2014

(30) Foreign Application Priority Data
May 14, 2012 (JP) 2012-110461

(51) Int. Cl. H04W 60/00; H04W 40/02

(52) U.S. Cl. CPC H04W 60/00; H04W 40/02
USPC 455/435.1

(57) ABSTRACT

A communication system includes a wireless terminal device related to a predetermined service or group, a relay device, a base station device to be connected to the relay device, a gateway device, and a mobile management device. In the relay device included in the communication system, a registration processing unit transmits to the mobile management device, a first registration request signal that requests registration of the relay device, and receives first communication path information indicating a communication path between the relay device and the gateway device. A device determination unit receives from the wireless terminal device, a connection request signal that requests connection, and determines based on the connection request signal whether or not to transfer data related to the wireless terminal device. A data transfer unit transfers the data using the communication path indicated by the first communication path information.

### TECHNICAL FIELD

The present invention relates to a relay device, a wireless terminal device, a communication system and a communication method.

Priority is claimed on Japanese Patent Application No. 2012-110461, filed May 14, 2012, the content of which is incorporated herein by reference.

### BACKGROUND ART

Machine type communication (MTC, which is also referred to as machine communication) systems to be performed autonomously between devices without involving determination of users have been conventionally developed. Regarding the machine type communication, a wide range of applications, such as remote management of vending machines or the like, management of the royalty of public services such as power and gas, have been attempted. Non-Patent Document 1 discloses types of wireless communication network including a plurality of MTC-dedicated terminals (MTC devices).

### CITATION LIST

### Non-Patent Document

[Non-Patent Document 1] 3GPP TS 22.368 Service Requirements for Machine-Type Communications (MTC) Stage 1, 3GPP Organizational Partners, 2011.2, V10.3.1

### DISCLOSURE OF THE INVENTION

### Problems to be Solved by the Invention

However, in a case where the MTC devices simultaneously access a wireless communication network described in Non-Patent Document 1, signaling with an MME (mobility management entity; mobile management device) that manages mobility of terminals is concentrated, thereby causing excessive load on the MME, and thus causing congestion of processing in some cases. This has caused transmission and reception of data to fail.

The present invention has been made in view of the above respect, and provides a relay device that reduces the load on the MME, a wireless terminal device, a communication system and a communication method.

### Means for Solving the Problems

(1) The present invention has been made to solve the above problem. One embodiment of the present invention is a relay device including: a registration processing unit configured to transmit to a mobile management device, a first registration request signal that requests registration of the relay device, and receive first communication path information indicating a communication path between the relay device and a gateway device; a device determination unit configured to receive a connection request signal that requests connection, from a wireless terminal device related to a predetermined group or service, and determine based on the connection request signal whether or not to transfer data related to the wireless terminal device; and a data transfer unit configured to transfer the data related to the wireless terminal device using the communication path indicated by the first communication path information.
(2) Regarding the relay device according to another aspect of the present invention, the registration processing unit is configured to transmit to the mobile management device, a second registration request signal that requests registration of the wireless terminal device, receive a second communication path information indicating a communication path between the wireless terminal device and the gateway device, and transmit the second communication path information to the wireless terminal device.
(3) Regarding the relay device according to another aspect of the present invention, the registration processing unit is configured to receive from the wireless terminal device, a registration request signal that requests registration of the wireless terminal device, and transmit the received registration request signal as the second registration request signal.
(4) The relay device according to another aspect of the present invention further includes a mode determination unit configured to determine whether to transfer data using the communication path indicated by the first communication path information or the communication path indicated by the second communication path information.
(5) Regarding the relay device according to another aspect of the present invention, the mode determination unit is configured to, in a case that a base station device connected to the relay device is changed to another base station device, determine to transfer data using the communication path indicated by the first communication path information.
(6) The relay device according to another aspect of the present invention further includes a mode control unit configured to, in a case that it is determined to transfer data using the communication path indicated by the first communication path information, transmit to the wireless terminal device, a communication mode signal indicating that data is to be transferred using the communication path.
(7) Regarding the relay device according to another aspect of the present invention, the registration processing unit is configured to, after the base station device connected to the relay device is changed to the other base station device, transmit to the mobile management device, a second registration request signal that requests registration of the wireless terminal device.
(8) The relay device according to another aspect of the present invention further includes an address management unit configured to assign different addresses to the wireless terminal devices.
(9) Another aspect of the present invention is a wireless terminal device including: a communication control unit configured to transmit to a relay device, a connection request signal that requests connection between the relay device and the wireless terminal device related to a predetermined service or group, and receive an address generated by the relay device; and a transceiver unit configured to transmit and receive, using the received address, data to and from a communication destination device related to the service or group, via a first communication path between the relay device and a gateway device.
(10) Regarding the wireless terminal device according to another aspect of the present invention, the communication control unit is configured to transmit a registration request signal that requests registration of the wireless terminal device, and the communication control unit is configured not to transmit the registration request signal in a case that a communication mode signal is received from the relay device, the communication mode signal indicating that data is to be transferred using a communication path between the relay device and a gateway device, and the communication path being indicated by first communication path information.
(11) Another aspect of the present invention is a communication system including: a wireless terminal device related to a predetermined service or group; a relay device; a base station device to be connected to the relay device; a gateway device; and a mobile management device. The relay device includes: a registration processing unit configured to transmit to the mobile management device, a first registration request signal that requests registration of the relay device, and receive first communication path information indicating a communication path between the relay device and the gateway device; a device determination unit configured to receive from the wireless terminal device, a connection request signal that requests connection, and determine based on the connection request signal whether or not to transfer data related to the wireless terminal device; and a data transfer unit configured to transfer the data using the communication path indicated by the first communication path information.
(12) Regarding the communication system according to another aspect of the present invention, the registration processing unit is configured to transmit to the mobile management device, a second registration request signal that requests registration of the wireless terminal device, and receive second communication path information indicating a communication path between the wireless communication device and the gateway device. The relay device further includes a mode determination unit configured to determine whether to transfer data using the communication path indicated by the first communication path information or the communication path indicated by the second communication path information, the mode determination unit being configured to, in a case that a base station device connected to the relay device is changed to another base station device, determine to transfer data using the communication path indicated by the first communication path information.
(13) Another aspect of the present invention is a communication method for a communication system including a wireless terminal device related to a predetermined service or group, a relay device, a base station device to be connected to the relay device, a gateway device, and a mobile management device. The communication method includes: a first step for the relay device to transmit to the mobile management device, a first registration request signal that requests registration of the relay device, and receive first communication path information indicating a communication path between the relay device and the gateway device; a second step for the relay device to receive from the wireless terminal device, a connection request signal that requests connection, and determine based on the connection request signal whether or not to transfer data related to the wireless terminal device; and a third step for the relay device to transfer the data using the communication path indicated by the first communication path information.

### Effects of the Invention

According to the embodiments of the present invention, the load on the mobile management device (MME) that manages terminals in the wireless communication system is reduced.

### BRIEF DESCRIPTION OF THE DRAWINGS

FIG. 1 is a schematic diagram showing a communication system according to a first embodiment of the present invention.

FIG. 2 is a schematic diagram showing a structure of an RN according to the present embodiment.

FIG. 3 is a diagram showing an example of MTC service information according to the present embodiment.

FIG. 4 is a diagram showing an example of MTC group information according to the present embodiment.

FIG. 5 is a diagram showing an example of address information according to the present embodiment.

FIG. 6 is a schematic diagram showing a configuration of a base station device according to the present embodiment.

FIG. 7 is a schematic diagram showing a configuration of an MTC terminal device according to the present embodiment.

FIG. 8 is a sequence diagram showing a communication process according to the present embodiment.

FIG. 9 is a schematic diagram showing a configuration of an RN according to a second embodiment of the present invention.

FIG. 10 is a schematic diagram showing a configuration of an MTC terminal device according to the present embodiment.

FIG. 11 is a sequence diagram showing a communication process according to the present embodiment.

FIG. 12 is a schematic diagram showing a configuration of an RN according to a third embodiment of the present invention.

FIG. 13 is a schematic diagram showing a configuration of an MTC terminal device according to the present embodiment.

FIG. 14 is a sequence diagram showing a communication process according to the present embodiment.

FIG. 15 is a schematic diagram showing a communication system according to a fourth embodiment of the present invention.

FIG. 16 is a schematic diagram showing a configuration of an RN according to the present embodiment.

FIG. 17 is a schematic diagram showing a configuration of a base station device according to the present embodiment.

FIG. 18 is a sequence diagram showing a communication process according to the present embodiment.

FIG. 19 is a sequence diagram showing a modified example of the communication process according to the present embodiment.

### BEST MODE FOR CARRYING OUT THE INVENTION

### First Embodiment

Hereinafter, a first embodiment of the present invention will be described with reference to the drawings.

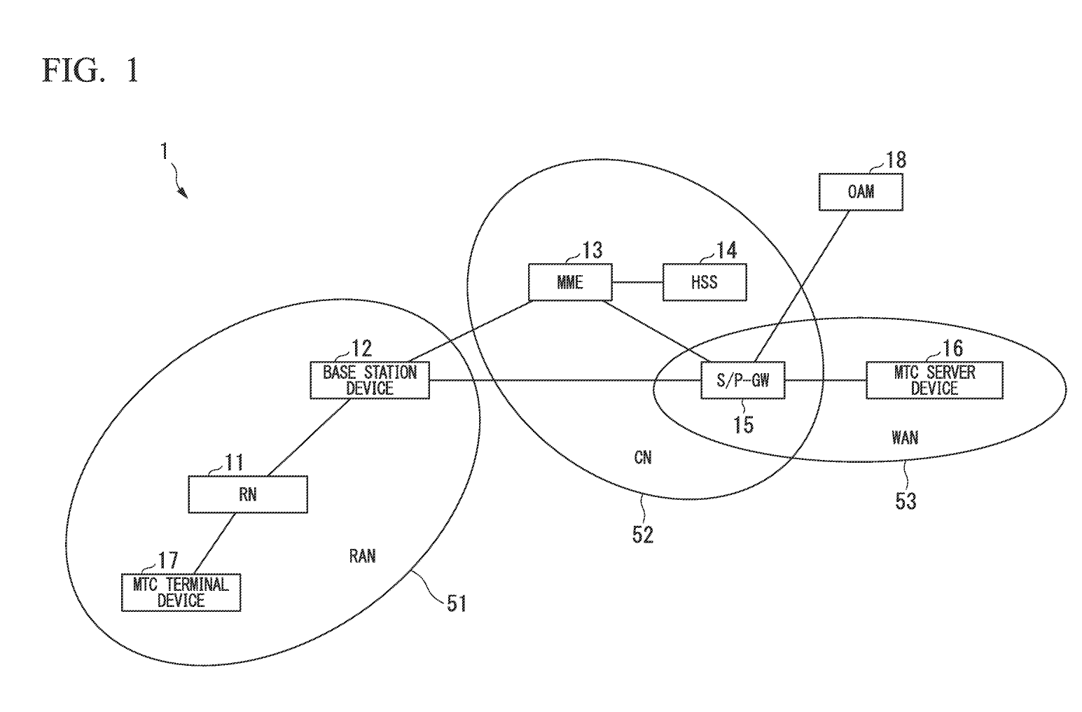

FIG. 1 is a schematic diagram showing a communication system 1 according to the present embodiment.

The communication system 1 according to the present embodiment includes an RN (a relay node; a relay device) 11, a base station device 12, an MME (a mobility management entity; a mobile management device) 13, an HSS (a home subscriber server; a subscriber device) 14, an S/P-GW (a serving gateway/packet data network gateway; a gateway device/packet data network gateway) 15, an MTC (machine type communication; machine type communication) server device 16, an MTC terminal device 17, an OAM (operation and maintenance; an operation and maintenance server device) 18, an RAN (radio access network) 51; a CN (core network; which is also called a backbone network) 52, and a WAN (wide area network; a wide area network) 53.

The RAN 51 is a network that wirelessly connects the base station device 12, the RN 11, and the MTC terminal device 17. In the RAN 51, an example of protocol used for connection is RRC (radio resource control) protocol.

The CN 52 is a network that wirelessly or wiredly connects the MME 13, the HSS 14, and the S/P-GW 15.

The WAN 53 is a wide-area network (e.g., the Internet) that connects at least the S/P-GW 15 and the MTC server device 16 as components (entities).

The RN 11 relays data transmitted and received between the base station device 12 and the MTC terminal device 17. The RN 11 transmits and receives data to and from the MTC terminal device 17, and transmits and receives data to and from the base station device 12. The RN 11 transmits to the base station device 12, data received from the MTC terminal device 17, and transmits to the MTC terminal device 17, data received from the base station device 12. The RN 11 generates a connection request signal which requests a connection between the RN 11 and the base station device 12, and transmits the generated connection request signal to the base station device 12. Thereafter, the RN 11 receives from the base station device 12, a connection response signal indicating that communication is available. If a connection response signal is not received within a predetermined time (e.g., 90 seconds) after the connection request signal is transmitted, the RN 11 determines that the connection fails and thus terminates the connection process.

In the present embodiment, the RN 11 previously transmits to the MME 13, a first registration request signal that requests registration of the RN 11 as a device to be connected to a network for the communication system 1 (for example, the RAN 51). The first registration request signal is a signal different from the above-described connection request signal. The RN 11 receives first communication path information indicating a communication path between the RN 11 and the S/P-GW 15 via the base station device 12. The RN 11 receives from the MTC terminal device 17, a connection request signal that requests a connection between the RN 11 and the MTC terminal device 17. Based on the connection request signal received from the MTC terminal device 17, the RN 11 determines whether or not to transfer data related to the MTC terminal device 17.

The data related to the MTC terminal device 17 includes both data received from the MTC terminal device 17 and data to be transmitted to the MTC terminal device 17. The RN 11 transfers data to the MTC server device 16 connected to the S/P-GW 15, using a communication path indicated by the received communication path information.

After receiving from the MME 13, a registration acceptance signal that will be described later, the RN 11 generates service setting information request signal. The service setting information request signal is a signal that requests service setting information (which will be described later) from a transmission destination device (e.g., the MTC server device 16). The service setting information is setting information to be used to provide MTC services. Based on bearer information included in the registration acceptance signal (which will be described later), the RN 11 transmits service setting information to the MTC server device 16 via the S/P-GW 15. The RN 11 receives the service setting information from the MTC server device 16. A configuration of the RN 11 will be described later.

The base station device 12 is a base station device to wirelessly transmit and receive data to and from the MTC terminal device 17 via the RN 11. The base station device 12 may transmit and receive data directly to and from another terminal device (e.g., a cellular phone, a mobile information terminal device, etc.). An example of the base station device 12 is a DeNB (Donor eNodeB, a donor base station device).

When a connection request signal is received from the RN 11 that is a transmission source device, the base station device 12 generates a connection response signal indicating that communication is available. The base station device 12 transmits the generated connection response signal to the transmission source device.

The base station device 12 transmits the signal received from the RN 11, to the transmission destination device (e.g., the MME 13, the S/P-GW 15)

The MME 13 receives the registration request signal (first registration request signal) from the transmission source device (e.g., the RN 11) via the base station device 12. The MME 13 transmits to the HSS 14, a user inquiry signal that inquires whether or not the transmission source device associated with the received registration request signal is a valid user. Thereafter, the MME 13 receives user information from the HSS 14. In a case where the MME 13 receives user information indicating that the received user information is a valid user, the MME 13 generates a bearer setting request signal, and transmits the generated bearer setting request signal to the S/P-GW 15. The bearer setting request signal is a signal that requests setting of a bearer (communication path) between a transmission source device and a transmission destination device (e.g., the S/P-GW 15). The MME 13 defines as the above-described transmission source device, a device to be registered which is indicated by the registration request signal.

Thereafter, the MME 13 receives the bearer information from the S/P-GW 15, and generates a registration acceptance signal indicating that the MME 13 accepts the registration of the transmission source device having transmitted the received registration request signal. The registration acceptance signal includes the received bearer information. The MME 13 transmits the generated registration acceptance signal to the transmission source device.

In a case where the bearer information is not received within a predetermined time (e.g., 90 seconds) after the bearer setting request signal is transmitted, the MME 13 determines that the registration process has failed. Additionally, in a case where user information is not received within a predetermined time (e.g., 90 seconds) after the user inquiry signal is transmitted, or in a case where the received user information indicates that the user is not a valid user, the MME 13 determines that the registration process has failed. In a case where it is determined that the registration process has failed, the MME 13 generates a registration failure signal indicating a failure of the registration, and transmits the generated registration failure signal to the transmission source device.

Here, the MME 13 performs the transmission of the user inquiry signal, the transmission of the bearer setting request signal, and the transmission of the registration acceptance signal, based on the registration request signal (second registration request signal) received via the RN 11 and the base station device 12 from the MTC terminal device 17 that is the transmission source device.

The MME 13 transmits to the HSS 14, a user inquiry signal that inquires whether or not a user of the transmission source device (e.g., the RN 11) related to the registration request signal is a valid user. Thereafter, the MME 13 receives user information from the HSS 14. In a case where the MME 13 receives user information indicating that the received user information is a valid user, the MME 13 generates a bearer setting request signal, and transmits the generated bearer setting request signal to the S/P-GW 15. The bearer setting request signal is a signal that requests setting of a bearer (communication path) between a transmission source device and a transmission destination device (e.g., the S/P-GW 15).

Here, even in a case where a registration update request signal is received, the MME 13 performs transmission of a bearer setting request signal and transmission of a registration acceptance signal based on the registration update request signal, similarly to the case where the registration request signal is received. However, in this case, the MME 13 may omit the transmission of the user inquiry signal. Additionally, the MME 13 generates a registration update acceptance signal in lieu of the registration acceptance signal, and transmits the generated registration update acceptance signal.

The HSS 14 includes a user information storage unit that previously stores user information indicating a valid user and a device to be used by that user. The HSS 14 searches from the user information storage unit, a device (e.g., the RN 11) indicated by the user inquiry signal received from the MME 13. In a case where user information indicating a device matching the device indicated by the user inquiry signal is detected from the user information storage unit, the HSS 14 generates user information indicating that the user is a valid user. In a case where user information indicating a device matching the device indicated by the user inquiry signal cannot be detected from the user information storage unit, the HSS 14 generates user information indicating that the user is not a valid user. The HSS 14 transmits the generated user information to the MME 13.

The S/P-GW 15 includes an S-GW (a serving gateway, a service gateway device) and a P-GW (a packet data network gateway, a packet data network gateway device). The S-GW and the P-GW may be configured separately from each other as long as the S-GW and the P-GW cooperates with each other.

The S/P-GW 15 sets a bearer between the transmission source device (e.g., the RN 11) indicated by the bearer setting request signal received from the MME 13 and its own device (the S/P-GW 15) that is the transmission destination device. The S/P-GW 15 generates bearer information including global addresses of the transmission source device, the S/P-GW 15, and a relay device. An example of the global address is an address uniquely assigned to a device connected to the Internet. For example, in a case where the transmission source device is the RN 11, the relay device is the base station device 12. In a case where the transmission source device is the MTC terminal device 17, the relay devices are the RN 11 and the base station device 12. The S/P-GW 15 transmits the generated bearer information to the MME 13.

The S/P-GW 15 transmits to the transmission destination device (e.g., the MTC server device 16), the service setting information request signal received from the RN 11. The S/P-GW 15 transmits to the RN 11, the service setting information received from the MTC server device 16.

The S/P-GW 15 removes a tunnel header from the data packet received from the RN 11, and transmits to the transmission destination device, the data packet from which the tunnel header has been removed. The tunnel header is data including an address of the transmission source device at a starting point of the tunnel, and an address of the transmission destination device at an end point of the tunnel. The data packet to be transmitted to the MTC server device 16 includes, for example, an address of the MTC server device 16 as the transmission destination address.

The MTC server device 16 is a server device belonging to an MTC group, or a server device related to a certain MTC service. The MTC group is a group including a plurality of devices related to one MTC. The MTC service is a service provided by MTC.

The MTC server device 16 includes a storage unit that previously stores the service setting information related to a service provided by MTC. The service setting information varies depending on a service to be provided. For example, in a case where the service is a service of monitoring a parking area, the service setting information includes coding scheme information for encoding an image signal indicating an image of a parking lot. The MTC server device 16 receives a service setting information request signal from the RN 11 via the S/P-GW 15, and thereafter transmits the service setting information to the RN 11 via the S/P-GW 15.

The MTC server device 16 retrieves the data generated by the MTC terminal device 17, from the data packet received from the MTC terminal device 17 via the S/P-GW 15. The MTC server device 16 has a functional unit that performs a predetermined process using the retrieved data. For example, in a case where the retrieved data is an image signal indicating an image of a parking lot around the MTC terminal device 17, the MTC server device 16 may include a display unit that displays an image based on the image signal. For example, in a case where the retrieved data is a measured value of measurement performed by a sensor included in the MTC terminal device 17, the MTC server device 16 may include a data display unit that displays the measured value as an image.

The MTC terminal device 17 is a terminal device belonging to a predetermined MTC group, or a terminal device related to a predetermined MTC service, and is a terminal device that wirelessly transmits and receives data via the RN 11. The MTC terminal device 17 generates data related to the MTC group or the MTC service, and transmits a data packet including the generated data to a transmission destination device (e.g., the MTC server device 16) predetermined for each MTC group or each MTC service.

In the present embodiment, the MTC terminal device 17 transmits to the RN 11, a connection request signal that requests a connection between the MTC terminal device 17 and the RN 11. Additionally, the MTC terminal device 17 transmits to the MME 13 via the RN 11 and the base station device 12, a registration request signal that requests the MME 13 to register the MTC terminal device 17. However, when receiving an MTC communication mode specification signal from the RN 11, the MTC terminal device 17 does not transmit a registration request signal. The MTC communication mode specification signal is a signal that specifies that communication be performed in a communication mode for transferring the data using a communication path between the RN 11 and the S/P-GW 15. The MTC terminal device 17 transmits or receives via the RN 11, data to and from the MTC server device 16 connected to the S/P-GW 15.

A configuration of the MTC terminal device 17 will be described later.

The OAM 18 includes a storage unit that stores setting parameter information of the RN 11 and the base station device 12, and identification information of those devices, while associating the setting parameter information of each device with the identification information of the device. The setting parameter information includes, for example, setting parameters to be used when the RN 11 and the base station device 12 transmit and receive data to and from a terminal device (for example, a cell ID, a frequency band, a bandwidth, etc.).

When receiving a setting parameter request signal from the RN 11, the OAM 18 transmits the setting parameter information to the RN 11. The setting parameter request signal is a signal that requests setting parameter information.

Next, the configuration of the RN 11 will be described.

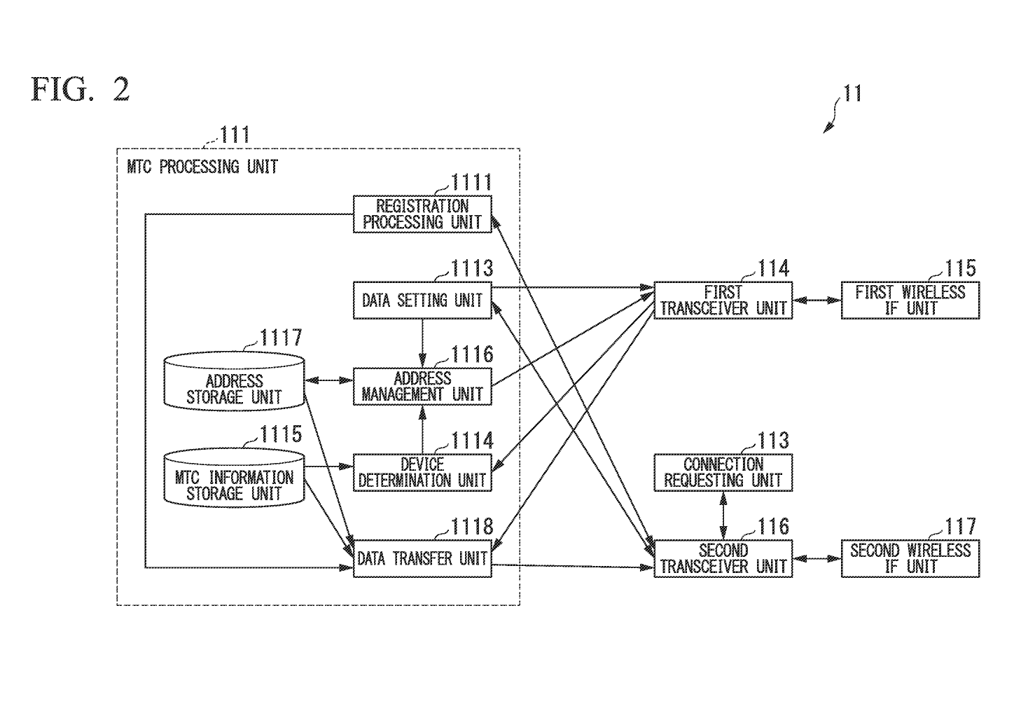

FIG. 2 is a schematic diagram showing a configuration of the RN 11 according to the present embodiment.

The RN 11 includes an MTC processing unit 111, a connection requesting unit 113, a first transceiver unit 114, a first wireless IF unit 115, a second transceiver unit 116, and a second wireless IF unit 117.

The MTC processing unit 111 includes a registration processing unit 1111, a data setting unit 1113, a device determination unit 1114, an MTC information storage unit 1115, an address management unit 1116, an address storage unit 1117, and a data transfer unit 1118.

The registration processing unit 1111 generates the above-described registration request signal and outputs the generated registration request signal to the second transceiver unit 116, as a transmission signal to be transmitted to the MME 13. The registration processing unit 1111 receives from the second transceiver unit 116, a registration acceptance signal as a reception signal received from the MME 13. The registration processing unit 1111 retrieves bearer information from the received registration reception signal, and outputs the retrieved bearer information to the data transfer unit 1118.

The data setting unit 1113 generates a service setting information request signal, and outputs to the second transceiver unit 116, the generated service setting information request signal, as a transmission signal to be transmitted to the MTC server device 16 via the S/P-GW 15. The data setting unit 1113 receives from the second transceiver unit 116, a reception signal as service setting information received from the MTC server device 16 via the S/P-GW 15. The data setting unit 1113 sets the received service setting information. The process of setting the service setting information differs depending on an MTC service or MTC group. For example, in a case where the service setting information includes information indicating an image coding scheme to be used for a parking monitoring service (coding scheme information), the data setting unit 1113 outputs to the first transceiver unit 114, the received service setting information as a transmission signal to be transmitted to the MTC terminal device 17. The MTC terminal device 17 reads the coding scheme information from the service setting information received from the RN 11, and outputs the read coding scheme information to an image encoding unit or an image decoding unit. Thus, the MTC terminal device 17, which is the transmission source device, becomes able to collect image data and transmit the collected image data to the MTC server device 16, which is the transmission destination device.

After setting the service setting information, the data setting unit 1113 generates a setting parameter request signal, and outputs to the second transceiver unit 116, the generated setting parameter request signal as a transmission signal addressed to the OAM 18. The data setting unit 1113 receives from the second transceiver unit 116, setting parameter information as a reception signal received from the OAM 18, and outputs the received setting parameter information to the first transceiver unit 114. Using the setting parameter information received from the data setting unit 1113, the first transceiver unit 114 transmits a transmission signal to the MTC terminal device 17 or receives a reception signal from the MTC terminal device 17.

The device determination unit 1114 receives from the first transceiver unit 114, a connection request signal as a reception signal received from the MTC terminal device 17. The device determination unit 1114 retrieves from the received connection request signal, a device identifier that identifies the MTC terminal device 17, and the MTC group identifier or the MTC service identifier.

The device determination unit 1114 reads from the MTC information storage unit 1115, MTC service information or MTC group information respectively associated with the retrieved MTC service identifier or MTC group identifier. The MTC information storage unit 1115 previously stores the MTC service information or MTC group information. The MTC service information is information that associates an MTC service identifier, service name information, and an address of a transmission destination device (transmission destination address) with one another. The MTC group information is information that associates an MTC group identifier, group name information, and transmission destination address information with one another.

In a case where the device determination unit 1114 successfully reads MTC service information or MTC group information, the device determination unit 1114 outputs to the address management unit 1116, the retrieved device identifier and the read transmission destination address information.

The address management unit 1116 receives the device identifier and the transmission destination address information from the device determination unit 1114, and thereafter generates transmission source address information different from any one of the transmission source address information stored in the address storage unit 1117. The transmission source address information generated by the address management unit 1116 may be information indicating a local address to be recognized by the RN 11. Thus, the address management unit 1116 generates transmission source address information unique to the MTC terminal device 17. The address management unit 1116 stores in the address storage unit 1117, the device identifier, the generated transmission source address information, and the received transmission destination address information, and lastly, last reception time information indicating the time at which a signal is lastly received from the MTC terminal device 17, while associating those information with one another.

The address management unit 1116 generates a connection response signal including the generated transmission source address information and outputs to the first transceiver unit 114, the generated connection response signal as a transmission signal to be transmitted to the MTC terminal device 17.

In a case where no signal is received from the MTC terminal device 17 even after a predetermined time (e.g., one hour) elapses from the last reception time, the address management unit 1116 may delete the device identifier, the transmission source address information, the received transmission destination address information, and the last reception time information, which are associated with one another and stored in the address storage unit 1117. Thus, the transmission source address information which has not been used for a given time is invalidated to avoid depletion of the transmission source address information.

When an address inquiry signal is received from the first transceiver unit 114 as a reception signal received from the MTC terminal device 17, the address management unit 1116 retrieves an MTC service identifier or MTC group identifier from the received address inquiry signal. The address management section 1116 reads from the MTC information storage unit 1115, MTC service information or MTC group information respectively associated with the retrieved MTC service identifier or MTC group identifier. The address management unit 1116 generates an address response signal including transmission destination address information included in the read MTC service information or MTC group information. The address management unit 1116 outputs to the first transceiver unit 114, the generated addresses response signal as a transmission signal addressed to the MTC terminal device 17.

The data transfer unit 1118 receives from the first transceiver unit 114, a data packet as a reception signal received from the MTC terminal device 17. The data transfer unit 1118 retrieves transmission source address information from the received data packet, and determines whether or not transmission source address information matching the retrieved transmission source address information is stored in the address storage unit 1117. A case where transmission source address information matching the retrieved transmission source address information is stored in the address storage unit 1117 means that the MTC terminal device 17 as the transmission source is related to the MTC service or MTC group predetermined by the MTC terminal device 17. A case where transmission source address information matching the retrieved transmission source address information is not stored in the address storage unit 1117 includes, for example, a case where the received data packet is a data packet transmitted from a device not related to the predetermined MTC service or MTC group. Other than this case, there is a case where the transmission source address information included in the received data packet indicates a global address.

In a case where transmission source address information matching the retrieved transmission source address information is stored in the address storage unit 1117, the data transfer unit 1118 performs the following process. The data transfer unit 1118 reads from the address storage unit 1117, transmission destination address information associated with the retrieved transmission source address information. Then, the data transfer unit 1118 replaces with the read transmission destination address information, the transmission destination address information stored in a header of the received data packet. The replaced transmission destination address information is information indicating an address of the MTC server device 16 that is the transmission destination device related to the MTC service or MTC group. The data transfer unit 1118 generates a tunnel header including the transmission source address information (e.g., an address of the RN 11) indicated by the bearer information received from the registration processing unit 1111 and the transmission destination address information (e.g., an address of the S/P-GW 15). The data transfer unit 1118 adds a tunnel header to the data packet including the replaced transmission destination address information, and thus generates a tunnel data packet. The data transfer unit 1118 outputs to the second transceiver unit 116, the generated tunnel data packet as a transmission signal to be transmitted to a transmission destination device (e.g., the MTC server device 16) via the communication path indicated by the bearer information. Thus, the data packets transmitted from the MTC terminal device 17 to the RN 11 are transmitted to the MTC server device 16 via the RN 11 and the S/P-GW 15, as the predetermined communication path.

In a case where transmission source address information matching the retrieved transmission source address information is not stored in the address storage unit 1117, the data transfer unit 1118 outputs to the second transceiver unit 116, the data packet received from the first transceiver unit 114. Thus, the reception signal is simply relayed to the transmission destination device.

The connection requesting unit 113 previously generates a connection request signal that requests a connection, and outputs to the second transceiver unit 116, the generated connection request signal as a transmission signal to be transmitted to the base station device 12. The connection requesting unit 113 receives from the second transceiver unit 116, the connection response signal as a reception signal received from the base station device 12. Thus, a connection between the RN 11 and the base station device 12 (e.g., RRC connection) is established. However, in a case where a time interval from the time the connection request signal is transmitted to the time a connection response signal is received exceeds a preset time (for example, 90 seconds), the connection requesting unit 113 determines that establishment of a connection fails, and terminates the process.

The first transceiver unit 114 converts a transmission signal received from the MTC processing unit 111 into a transmission signal in a wireless frequency band, and outputs to the first wireless IF unit 115, the converted transmission signal in the wireless frequency band. The first transceiver unit 114 converts a reception signal in the wireless frequency band received from the first wireless IF unit 115 into a reception signal in a base frequency band, and outputs the converted reception signal to the MTC processing unit 111.

The first wireless IF unit 115 is an interface that wirelessly transmits and receives signals to and from the MTC terminal device 17. The first wireless IF unit 115 transmits, by means of radio waves, the transmission signal received from the first transceiver unit 114, to the MTC terminal device 17 via the RAN 51. The first wireless IF unit 115 receives, by means of radio waves, a reception signal from the MTC terminal device 17 via the RAN 51, and outputs the received reception signal to the first receiving unit 114.

The second transceiver unit 116 converts the transmission signal received from the MTC processing unit 111 or the connection requesting unit 113 into a transmission signal in the wireless frequency band, and outputs the converted transmission signal to the second wireless IF unit 117. The second transceiver unit 116 converts the reception signal in the wireless frequency band received from the second wireless IF unit 117 into a reception signal in the base frequency band, and outputs the converted reception signal to the MTC processing unit 111 or the connection requesting unit 113. Here, the wireless frequency band used by the second transceiver unit 116 may be different from the wireless frequency band used by the first transceiver unit 114. Thus, it is possible to avoid interference between radio waves used for transmission and reception to and from the MTC terminal device 17 and radio waves used for transmission and reception to and from the base station device 12.

The second wireless IF unit 117 is an interface that wirelessly transmits and receives signals to and from the MTC terminal device 17. The second wireless IF unit 117 transmits, by means of radio waves, a transmission signal received from the second transceiver unit 116, to the base station device 12 via the RAN 51. The second wireless IF unit 117 receives, by means of radio waves, a reception signal from the base station device 12 via the RAN 51, and outputs the received reception signal to the second transceiver unit 116.

Next, MTC service information according to the present embodiment will be described.

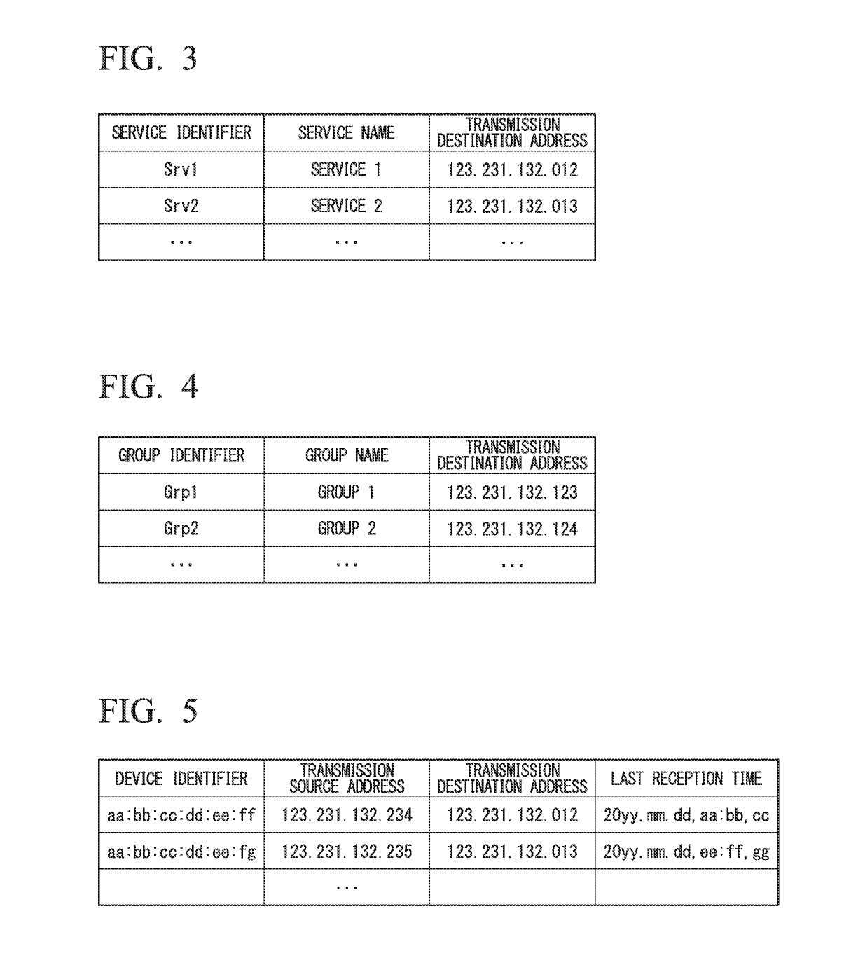

FIG. 3 is a diagram showing an example of MTC service information according to the present embodiment.

FIG. 3 shows a service identifier, service name information, and transmission destination address information, in this order from the leftmost side to the right side. Regarding the second row counted from the top row shown in FIG. 3, the service name information associated with the service identifier Srv1 indicates service 1, and the transmission destination address information indicates 123.231.132.012. Regarding the third row counted from the top row shown in FIG. 3, the service name information associated with the service identifier Srv2 indicates service 2, and the transmission destination address information indicates 123.231.132.013.

Next, MTC group information according to the present embodiment will be described.

FIG. 4 is a diagram showing an example of the MTC group information according to the present embodiment.

FIG. 4 shows a group identifier, group name information, and transmission destination address information, in this order from the leftmost side to the right side. Regarding the second row counted from the top row shown in FIG. 4, the group name information associated with the group identifier Grp1 indicates group 1, and the transmission destination address information indicates 123.231.132.123. Regarding the third row counted from the top row shown in FIG. 4, the group name information associated with the group identifier Grp2 indicates group 2, and the transmission destination address information indicates 123.231.132.124.

Next, address information according to the present embodiment will be described.

FIG. 5 is a diagram showing an example of the address information according to the present embodiment.

FIG. 5 shows a device identifier, transmission source address information, transmission destination address information, and last reception time information, in this order from the leftmost side to the right side.

Regarding the second row counted from the top row shown in FIG. 5, the transmission source address information associated with the device identifier aa: bb: cc: dd: ee: ff indicates 123.231.132.234. The transmission destination address information indicates 123.231.132.012. The last reception time information indicates 20yy.mm.dd.aa.bb.cc (year.month.day.hour.minute.second).

Regarding the third row counted from the top row shown in FIG. 5, the transmission source address information associated with the device identifier aa: bb: cc: dd: ee: fg indicates 123.231.132.235. The transmission destination address information indicates 123.231.132.013. The last reception time information indicates 20yy.mm.dd.ee.ff.gg (year.month.day.hour.minute.second).

Next, a configuration of the base station device 12 according to the present embodiment will be described.

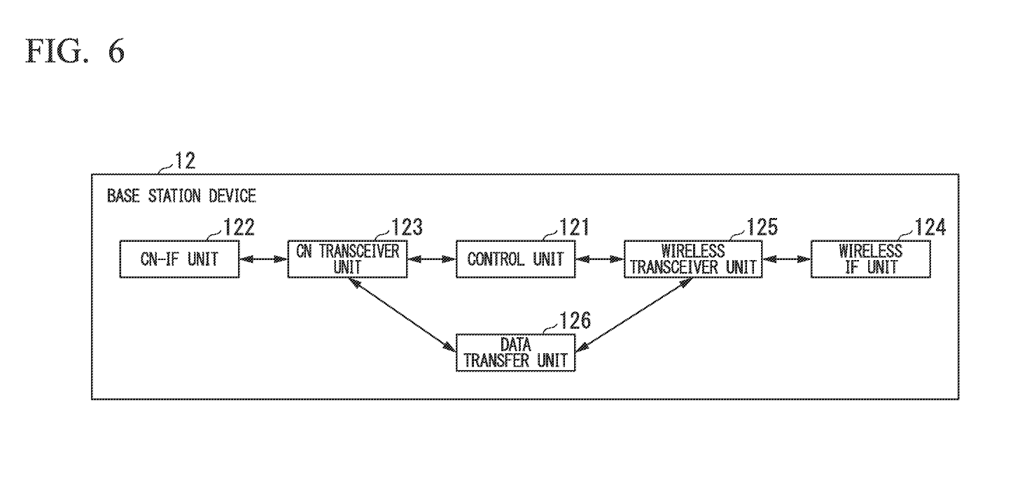

FIG. 6 is a schematic diagram showing the configuration of the base station device 12 according to the present embodiment.

The base station device 12 includes a control unit 121, a CN-IF (interface) unit 122, a CN transceiver unit 123, a wireless IF unit 124, a wireless transceiver unit 125, and a data transfer unit 126.

When a connection request signal is received from the CN transceiver unit 123 as a reception signal received from the RN 11, the control unit 121 generates a connection response signal indicating that communication is available. The control unit 121 may add identification information of its own device (the base station device 12), for example, a cell ID, to generate a connection response signal. The control unit 121 may output to the CN transceiver unit 123, the generated connection response signal as a transmission signal addressed to the RN 11.

The CN-IF unit 122 is an input and output interface to be connected to the CN 52. The CN-IF unit 122 has a configuration in accordance with the function of the CN 52. In a case where the CN 52 is a wired network, the CN-IF unit 122 includes, for example, a connector. In a case where CN 52 is a wireless network, the CN-IF unit 122 includes, for example, an antenna.

The CN-IF unit 122 transmits the transmission signal received from the CN transceiver unit 123, to a transmission destination device connected to the CN 52, or to the transmission destination device via the CN 52. The CN-IF unit 122 receives a reception signal from the transmission destination device via the CN 52, and outputs the received reception signal to the CN transceiver unit 123.

The CN transceiver unit 123 converts the transmission signal received from the control unit 121 or the data transfer unit 126, into a predetermined format used for transmitting and receiving transmission signals to and from the CN 52. Then, the CN transceiver unit 123 outputs the converted transmission signal to the CN-IF unit 122. For example, in a case where the CN 52 is a wireless network, the converted transmission signal is a transmission signal in the wireless frequency domain converted from a transmission signal in the base frequency domain. In a case where the CN 52 is an optical line, the converted transmission signal is a transmission signal that is an optical signal converted from an electrical signal.

The CN transceiver unit 123 converts the reception signal received from the CN-IF unit 122, into a predetermined format used for the control unit 121 or the data transfer unit 126 to perform processing. Then, the CN transceiver unit 123 outputs the converted signal to the control unit 121 or the data transfer unit 126. For example, in a case where the CN 52 is a wireless network, the converted reception signal is a reception signal in the base frequency domain converted from a transmission signal in the wireless frequency domain. In a case where the CN 52 is an optical line, the converted reception signal is a reception signal that is an electrical signal converted from an optical signal.

The wireless IF unit 124 is an input and output interface to be connected to the RAN 51. The wireless IF unit 124 includes, for example, an antenna.

The wireless IF unit 124 transmits the transmission signal received from the wireless transceiver unit 125, to a device connected to the RAN 51, for example, the RN 11. The wireless IF unit 124 receives a reception signal from a transmission destination device, and outputs the received reception signal to the wireless transceiver unit 125.

The wireless transceiver unit 125 converts the transmission signal in the base frequency band received from the control unit 121 or the data transfer unit 126 into a transmission signal in the wireless frequency band. Then, the wireless transceiver unit 125 outputs the converted transmission signal to the wireless IF unit 124. The wireless transceiver unit 125 converts the reception signal in the wireless frequency band received from the wireless IF unit 124 into a reception signal in the base frequency band. Then, the wireless transceiver unit 125 outputs the converted reception signal to the control unit 121 or the data transfer unit 126.

The data transfer unit 126 outputs to the CN transceiver unit 123, the transmission signal addressed to the transmission destination device, which is received from the wireless transceiver unit 125. The transmission destination device is a device connected to the CN 52, for example, the S/P-GW 15, or a device connected via the CN 52, for example, the MTC server device 16.

The data transfer unit 126 outputs to the wireless transceiver unit 125, the transmission signal addressed to the transmission destination device, which is received from the CN transceiver unit 123. The transmission destination device is a device connected to the base station device 12, for example, the RN 11, or a device connected via the RN 11, for example, the MTC terminal device 17.

Next, a configuration of the MTC terminal device 17 according to the present embodiment will be described.

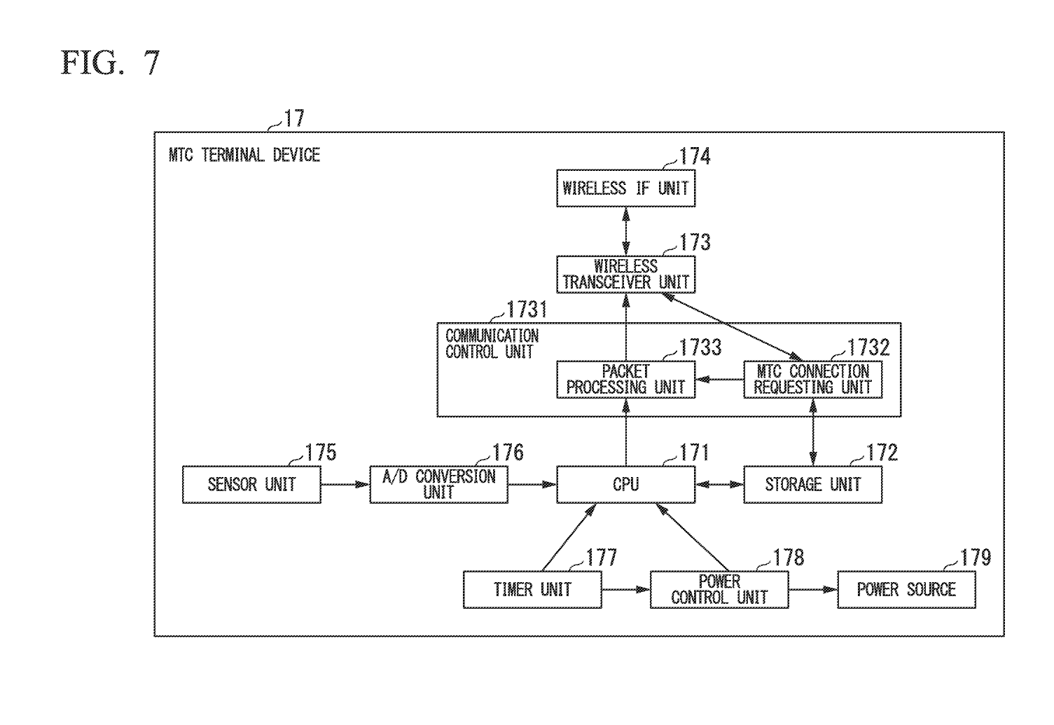

FIG. 7 is a schematic diagram showing the configuration of the MTC terminal device 17 according to the present embodiment.

The MTC terminal device 17 includes a CPU (central processing unit) 171, a storage unit 172, a wireless transceiver unit 173, a communication control unit 1731, a wireless IF unit 174, a sensor unit 175, an A/D (analog-to-digital) conversion unit 176, a timer unit 177, a power control unit 178, and a power source 179.

In a case where an activation instruction signal is received from the power control unit 178, the CPU 171 reads a program stored in the storage unit 172, executes the read program, and controls the operation of the entire MTC terminal device 17.

The CPU 171 outputs to the communication control unit 1731, digital data received from the A/D conversion unit 176. The digital data is a transmission signal to be transmitted to a transmission destination device (e.g., the MTC server device 16).

In a case where a termination instruction signal is received from the power control unit 178, the CPU 171 terminates the operation of the running program, terminates operations other than the operation of the timer unit 177 and the power control unit 178.

The wireless transceiver unit 173 down-converts the reception signal in the wireless frequency band received from the wireless IF unit 174 to generate a reception signal in the base frequency band. Then, the wireless transceiver unit 173 outputs the generated reception signal to the communication control unit 1731.

The wireless transceiver unit 173 up-converts the transmission signal in the base frequency band received from the communication control unit 1731 to generate a transmission signal in the wireless frequency band. Then, the wireless transceiver unit 173 outputs the generated transmission signal in the wireless frequency band to the wireless IF unit 174.

The communication control unit 1731 controls communication processes to be performed by the MTC terminal device 17, such as connection to the RN 11, and transmission and reception of data. The communication control unit 1731 includes an MTC connection requesting unit 1732 and a packet processing unit 1733. Additionally, the communication control unit 1731 receives, for example, an input through operation by a user and generates a registration request signal. The communication control unit 1731 outputs to the wireless transceiver unit 173, the generated registration request signal as a transmission signal to be transmitted to the MME 13 via the RN 11 and the base station device 12. However, in a case where an MTC communication mode specification signal is received from the wireless transceiver unit 173 as a reception signal received from the RN 11, the communication control unit 1731 does not output a registration request signal.

The MTC connection requesting unit 1732 performs a process of requesting a connection of its own device (MTC terminal device 17) to the RN 11, as a device that performs MTC. Here, the MTC connection requesting unit 1732 reads the device identifier and the MTC group identifier or MTC service identifier, which are previously stored in the storage unit 172. The MTC connection requesting unit 1732 generates a connection request signal including the read device identifier and the MTC group identifier or MTC service identifier, which requests a connection to the RN 11. The MTC connection requesting unit 1732 outputs to the wireless transceiver unit 173, the generated connection request signal as a transmission signal addressed to the RN 11. The MTC connection requesting unit 1732 receives a connection response signal from the wireless transceiver unit 173, as a reception signal received from the RN 11. Then, the MTC connection requesting unit 1732 retrieves transmission source address information from the received connection response signal, and outputs the retrieved transmission source address information to the packet processing unit 1733.

Here, in the case where a connection response signal is not received even after a predetermined time (e.g., 90 seconds) has elapsed from the time the connection request signal is transmitted, the MTC connection requesting unit 1732 determines that the connection request has failed, and terminates the process related to the connection request.

Here, in a case where transmission and reception of data is performed in a public communication mode that will be described later, the MTC connection requesting unit 1732 performs generation and output of a connection request signal also when a communication mode signal indicating the MTC communication mode is received from the wireless transceiver unit 173, as a reception signal received from the RN 11.

The packet processing unit 1733 generates a header including the transmission source address information received from the MTC connection requesting unit 1732, and the address of the RN 11 as the transmission destination address information. The packet processing unit 1733 adds the generated header to the digital data received from the CPU 171, thus generating a data packet. The packet processing unit 1733 outputs to the wireless transceiver unit 173, the data packet generated as a transmission signal addressed to the RN 11.

Thus, the MTC terminal device 17 can transmit data from the RN 11 to the MTC server device 16 via the predetermined communication path, and therefore does not have to request a registration each time. For this reason, it is possible to reduce the load on the MME 13.

The communication mode to be used for communication through the RN 11 via the predetermined communication path between the RN 11 and the S/P-GW 15 is the MTC communication mode.

The wireless IF unit 174 is an interface that wirelessly transmits and receives signals to and from the RN 11. The wireless IF unit 174 transmits to the RN 11 by means of electric waves, the transmission signal received from the wireless transceiver unit 173. The wireless IF unit 174 receives a reception signal from the RN 11 and outputs the received reception signal to the wireless transceiver unit 173. The wireless IF unit 174 includes, for example, a transceiver antenna.

The sensor unit 175 detects analog data indicating environments around the MTC terminal device 17.

Examples of the sensor unit 175 include a camera that captures an image, a temperature sensor that measures temperature.

The sensor unit 175 outputs the detected analog data to the A/D conversion unit 176.

The A/D conversion unit 176 performs A/D conversion on the analog data received from the sensor unit 175 to generate digital data. The A/D conversion unit 176 outputs the generated digital data to the CPU 171.

The timer unit 177 sequentially measures the current time, and outputs time information indicating the measured time, to the CPU 171 and the power control unit 178.

The power control unit 178 is previously set with scheduling information indicating information concerning an activation time for activating the power source 179 and a termination time for terminating each functional unit. However, the termination means that the operations of the timer unit 177 and the power control unit 178 continue and the functions of the other functional units are terminated. When the time information received from the timer unit 177 reaches the activation time indicated by the scheduling information, the power control unit 178 generates an activation instruction signal indicating activation. When the time information received from the timer unit 177 reaches the termination time indicated by the scheduling information, the power control unit 178 generates a termination instruction signal indicating termination. The power control unit 178 outputs to the CPU 171 and the power source 179, the generated activation instruction signal or termination instruction signal.

In the terminated state, the power consumption of the MTC terminal device 17 is much smaller than the power consumption in the operating state (e.g., less than 1/1000). Therefore, in a case where a time zone for transmitting and receiving data is preset, the scheduling information may be preset so that the MTC terminal device 17 is activated only in the time zone for transmitting and receiving data and is not activated in a time zone in which no data is transmitted or received. Thus, it is possible to save the power consumption of the MTC terminal device 17.

In a case where an activation instruction signal is received from the power control unit 178, the power source 179 supplies power to each unit of the MTC terminal device 17. After the termination instruction signal is received from the power control unit 178, the power source 179 terminates power supply to the units other than the timer unit 177 and the power control unit 178.

Next, a communication process according to the present embodiment will be described.

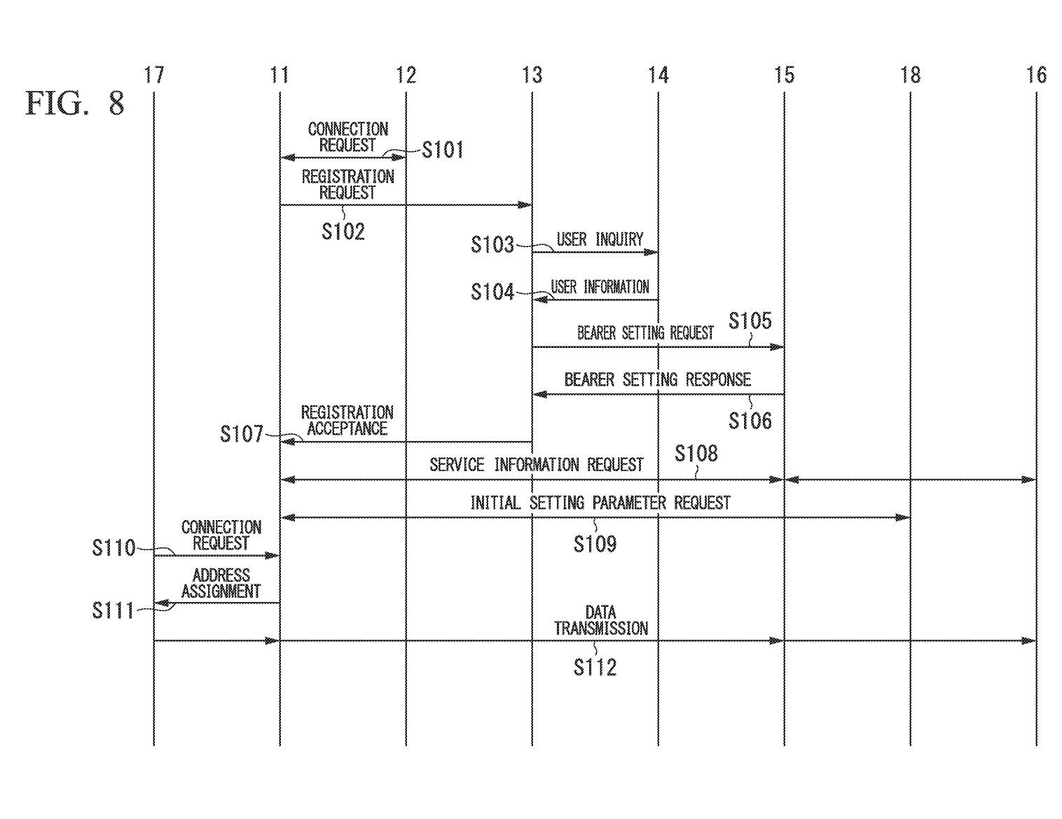

FIG. 8 is a sequence diagram showing the communication process according to the present embodiment.

(Step S101) The connection requesting unit 113 of the RN 11 previously generates a connection request signal, and transmits the connection request signal to the base station device 12.

The control unit 121 of the base station device 12 generates a connection response signal, and transmits the generated connection response signal to the RN 11.

The connection requesting unit 113 of the RN 11 receives a connection response signal from the base station device 12. Thus, connection is established between the RN 11 and the base station device 12. Then, the processing proceeds to step S102.

(Step S102) The registration processing unit 1111 of the RN 11 generates a registration request signal, and transmits the generated registration request signal to the MME 13. The MME 13 receives a registration request signal from the RN 11. Then, the processing proceeds to step S103.

(Step S103) The MME 13 generates a user inquiry signal and transmits the generated user inquiry signal to the HSS 14. The HSS 14 receives the user inquiry signal from the MME 13. Then, the processing proceeds to step S104.

(Step S104) If it is determined that the user of the RN 11 indicated by the user inquiry signal is a valid user, the HSS 14 generates user information indicating that determination. The HSS 14 transmits the generated user information to the MME 13. The MME 13 receives the user information from the HSS 14. Then, the processing proceeds to step S105.

(Step S105) The MME 13 generates a bearer setting request signal and transmits the generated bearer setting request signal to the S/P-GW 15. The S/P-GW 15 receives the bearer setting request signal from the MME 13. Then, the processing proceeds to step S106.

(Step S106) The S/P-GW 15 receives the bearer setting request signal from the MME 13. The S/P-GW 15 generates bearer information indicating a bearer between the RN 11 and the S/P-GW 15. The S/P-GW 15 transmits the generated bearer information to the MME 13 (bearer setting response). The MME 13 receives the bearer information from the S/P-GW 15. Then, the processing proceeds to step S107.

(Step S107) The MME 13 generates a registration acceptance signal including the received bearer information. The MME 13 transmits the generated registration acceptance signal to the RN 11. The registration processing unit 1111 of the RN 11 receives the registration acceptance signal from the MME 13. Then, the processing proceeds to step S108.

(Step S108) The data setting unit 1113 of the RN 11 generates a service setting information request signal, and transmits the generated service setting information request signal to the MTC server device 16 via the S/P-GW 15.

The MTC server device 16 transmits previously-stored service setting information to the data setting unit 1113 of the RN 11 via the S/P-GW 15.

The data setting unit 1113 performs a process of setting the received service setting information. Then, the processing proceeds to step S109.

(Step S109) The data setting unit 1113 of the RN 11 generates a setting parameter request signal, and transmits the generated setting parameter request signal to the OAM 18 (initial setting parameter request).

The OAM 18 transmits previously-stored setting parameter information to the RN 11.

Using the setting parameter information received from the OAM 18, the first transceiver unit 114 of the RN 11 receives a reception signal from the MTC terminal device 17 or transmits a transmission signal to the MTC terminal device 17. Then, the processing proceeds to step S110.

(Step S110) The MTC connection requesting unit 1732 of the MTC terminal device 17 generates a connection request signal including the device identifier and the MTC group identifier or MTC service identifier, which are previously set. The MTC connection requesting unit 1732 becomes able to transmit the generated connection request signal to the RN 11. Then, the processing proceeds to step S111.

(Step S111) The device determination unit 1114 of the RN 11 retrieves from the received connection request signal, the device identifier and the MTC group identifier or MTC service identifier.

The device determination unit 1114 outputs to the address management unit 1116, the retrieved device identifier, and MTC service information or MTC group information respectively associated with the retrieved MTC service identifier or MTC group identifier. The address management unit 1116 generates transmission source address information different from any one of the transmission source address information stored in the address storage unit 1117. Then, the address management unit 1116 generates a connection response signal including the generated transmission source address information. The address management unit 1116 transmits the generated connection response signal to the MTC terminal device 17 (address assignment).

The MTC connection requesting unit 1732 of the MTC terminal device 17 receives a connection response signal from the RN 11 and retrieves the transmission source address information. Then, the processing proceeds to step S112.

(Step S112) The packet processing unit 1733 of the MTC terminal device 17 generates a data packet including the retrieved transmission source address information as a header, and transmits the generated data packet to the RN 11.

The data transfer unit 1118 of the RN 11 replaces the transmission destination address information of the data packet received from the MTC terminal device 17 with the transmission destination address read from the address storage unit 1117. The data transfer unit 1118 generates a tunnel header including the transmission source address information and the transmission destination address information which are indicated by the bearer information. The data transfer unit 1118 adds the generated tunnel header to the data packet with the replaced transmission destination address, thus generating a new data packet. The data transmission unit 1118 transmits the generated data packet to the MTC server device 16 via the S/P-GW 15. Then, the processing ends.

Here, in the above-described communication process, step S109 may be performed in parallel with the processes in steps S102 to S107 (registration of the RN 11), and the process in step S108 (service setting information request).

Thus, the tunneling of the data signal is performed between the RN 11 and the S/P-GW 15, and data is transmitted from the MTC terminal device 17 to the MTC server device 16.

Thus, the present embodiment relates to the communication system 1 including the RN 11, the base station device 12 to be wirelessly connected to the RN 11, the S/P-GW 15, and the MME 13. The RN 11 transmits to the MME 13, a first registration request signal that requests registration of the RN 11, as a device to be connected to a network of the communication system 1. The RN 11 receives bearer information indicating a communication path between the RN 11 and the S/P-GW 15. The RN 11 receives from the MTC terminal device 17, a connection request signal that requests a connection to the RN 11. Then, based on the connection request signal, the RN 11 determines whether or not to transfer data related to the MTC terminal device 17. The RN 11 transfers the data to the transmission destination device, using the communication path indicated by the bearer information. Additionally, the MTC terminal device 17 transmits to the RN 11, a connection request signal that requests a connection between the RN 11 and the MTC terminal device 17 related to the predetermined MTC service or MTC group. Then, the MTC terminal device 17 receives the address generated by the RN 11. Using the received address, the MTC terminal device 17 transmits or receives data to and from the MTC server device 16 that is the transmission destination device related to the MTC service or MTC group, via the communication path between the RN 11 and the S/P-GW 15.

Thus, for a certain MTC group or MTC service, a communication path is previously secured between the RN 11 and the S/P-GW 15. Additionally, using the assigned address, the MTC terminal device 17 transmits and receives data to and from the MTC server device 16 via the secured communication path. Therefore, it is possible to prevent multiple MTC terminal devices 17 from simultaneously transmitting registration request signals to the MME 13 before transmitting data. Further, the MTC terminal device 17 does not have to establish a connection to an individual communication destination device. For this reason, the load of processing on the MME 13 is reduced.

### Second Embodiment

Next, a second embodiment of the present invention will be described. Hereinafter, the same reference numerals will be appended to the same configurations and processes as those of the above-described embodiment.

A communication system 2 according to the present embodiment (not shown) has a configuration similar to that of the communication system 1 (FIG. 1). However, the communication system 2 includes an RN 21 in lieu of the RN 11 (FIG. 1), and an MTC terminal device 27 in lieu of the MTC terminal device 17 (FIG. 1).

Here, a configuration of the RN 21 according to the present embodiment will be described.

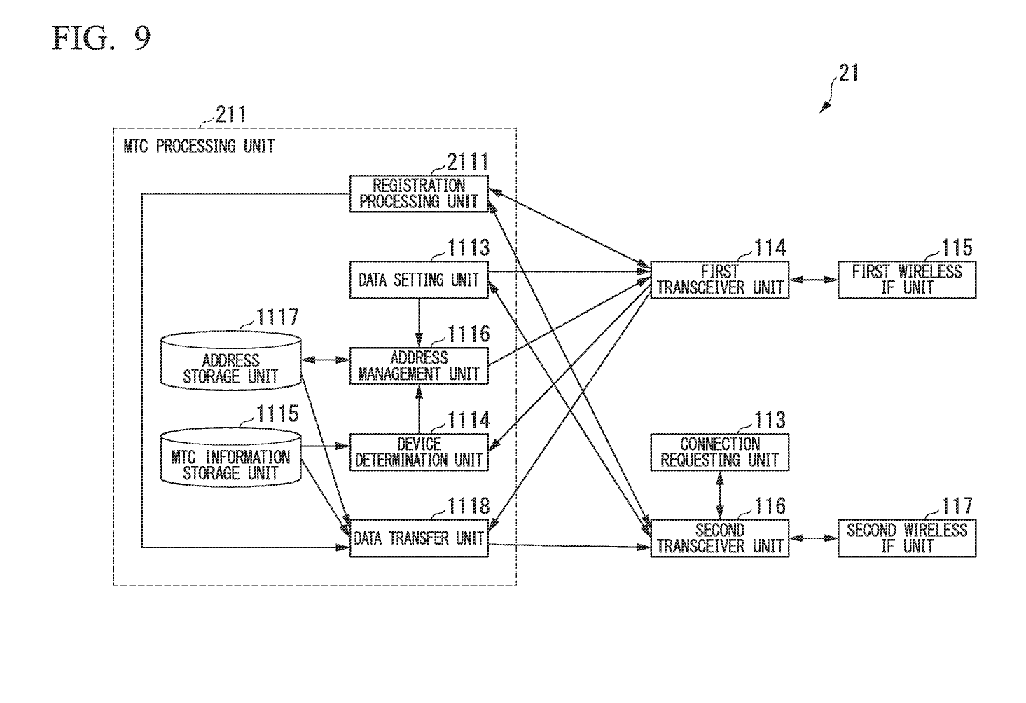

FIG. 9 is a schematic diagram showing the configuration of the RN 21 according to the present embodiment.

The RN 21 has a similar configuration to that of the RN 11 (FIG. 2). However, the RN 21 includes an MTC processing unit 211 in lieu of the MTC processing unit 111 (FIG. 2). The MTC processing unit 211 includes a registration processing unit 2111, in lieu of the registration processing unit 1111 (FIG. 2).

When a registration request signal (second registration request signal) is received from the first transceiver unit 114, as a reception signal received from the MTC terminal device 27, the registration processing unit 2111 outputs to the second transceiver unit 116, the received registration request signal as a transmission signal to be transmitted to the MME 13. The registration request signal to be output to the second transceiver unit 116 is a registration request signal that requests the MME 13 to register the MTC terminal device 27. Here, in a case where registration request signals are from a plurality of MTC terminal devices, the registration processing unit 2111 may collectively and simultaneously transmit the registration request signals to the MME 13. Thus, there becomes no need to perform signaling for registration for each MTC terminal device, and therefore reducing the processing load on the MME 13.

The registration processing unit 2111 receives from the second transceiver unit 116, a registration acceptance signal as a reception signal received from the MME 13. The registration processing unit 2111 outputs to the first transceiver unit 114, the registration acceptance signal as a transmission signal addressed to the MTC terminal device 27. The registration acceptance signal received from the second transceiver unit 116 indicates bearer information including a global address of the MTC terminal device 27 as transmission source address information and a global address of the S/P-GW 15 as transmission destination address information.

Here, a configuration of the MTC terminal device 27 according to the present embodiment will be described.

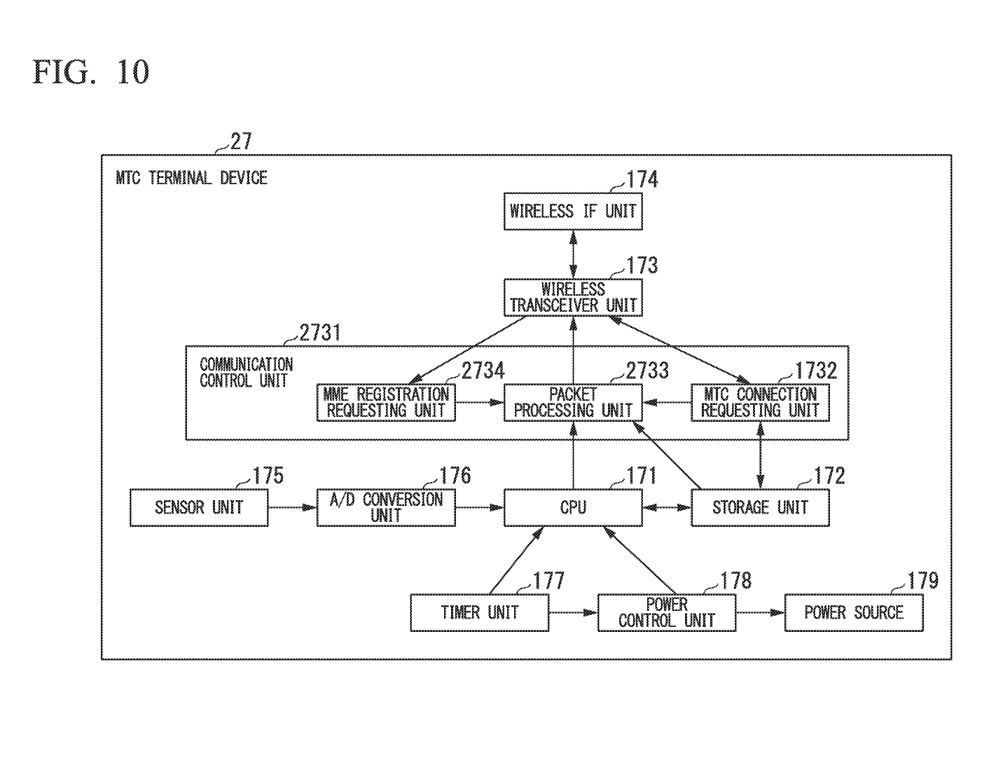

FIG. 10 is a schematic diagram showing the configuration of the MTC terminal device 27 according to the present embodiment.

The MTC terminal device 27 has a similar configuration to that of the MTC terminal device 17. However, the MTC terminal device 27 includes a communication control unit 2731 in lieu of the communication control unit 1731 (FIG. 7). The communication control unit 2731 includes a packet processing unit 2733 in lieu of the packet processing unit 1733 (FIG. 7), and further includes an MME registration requesting unit 2734.

The packet processing unit 2733 a configuration similar to that of the packet processing unit 1733 (FIG. 7), and further has a configuration described next. The packet processing unit 2733 obtains an address of a transmission destination device (e.g., the MTC server device 16). Here, for example, the packet processing unit 2733 may receive an input through operation by a user, and select a previously-stored transmission destination address. Other than that, the packet processing unit 2733 may generate an address inquiry signal that inquires a transmission destination address related to the MTC group or service for the MTC terminal device 27. Here, the packet processing unit 2733 reads an MTC service identifier or MTC group identifier from the storage unit 172, and includes the read MTC service identifier or MTC group identifier in the address inquiry signal. Then, the packet processing unit 2733 outputs to the wireless transceiver unit 173, the address inquiry signal as a transmission signal addressed to the RN 11. The packet processing unit 2733 receives from the wireless transceiver unit 173, the address response signal received from the RN 11. Then, the packet processing unit 2733 retrieves transmission destination address information from the received address response signal.

The packet processing unit 2733 adds to the digital data received from the CPU 171, a header including a global address of the MTC terminal device 27 as the received transmission source address information and the obtained transmission destination address information, thus generating a data packet.

The packet processing unit 2733 outputs to the wireless transceiver unit 173, the generated data packet as a transmission signal to be transmitted to the MTC server device 16 via the S/P-GW 15.

The MME registration requesting unit 2734 performs a process of requesting the MME 13 to register its own device (MTC terminal device 27) as a device to be connected to the base station device 12. The MME registration requesting unit 2734 generates a registration request signal (second registration request signal) that requests the MME 13 to register its own device (MTC terminal device 27). The MME registration requesting unit 2734 outputs to the wireless transceiver unit 173, the generated registration request signal as a transmission signal to be transmitted to the MME 13 via the RN 11 and the base station device 12.

A trigger for the MME registration requesting unit 2734 to output the registration request signal is, for example, a point of time at which an input through operation by a user is received, in a case where a transmission destination device other than the MTC server device 16 is specified and transmission of data is initiated (including a case where the MTC server device 16 is specified and data is transmitted).

The MME registration requesting unit 2734 receives from the wireless transceiver unit 173, registration acceptance information as a reception signal received from the MME 13 via the base station device 12 and the RN 11.

The MME registration requesting unit 2734 retrieves bearer information from the received registration acceptance information. The MME registration requesting unit 2734 retrieves from the retrieved bearer information, a global address assigned to the MTC terminal device 27 as transmission source address information, and a global address of the S/P-GW 15 as transmission destination address information. The MME registration requesting unit 2734 outputs to the packet processing unit 2733, the transmission source address information and the transmission destination address information which are retrieved from the bearer information.

Here, in the case where bearer information is not received even after a predetermined time (e.g., 90 seconds) elapses from the time the registration request signal is transmitted, the MME registration requesting unit 2734 determines that the registration request has failed, and terminates the process concerning the registration request.

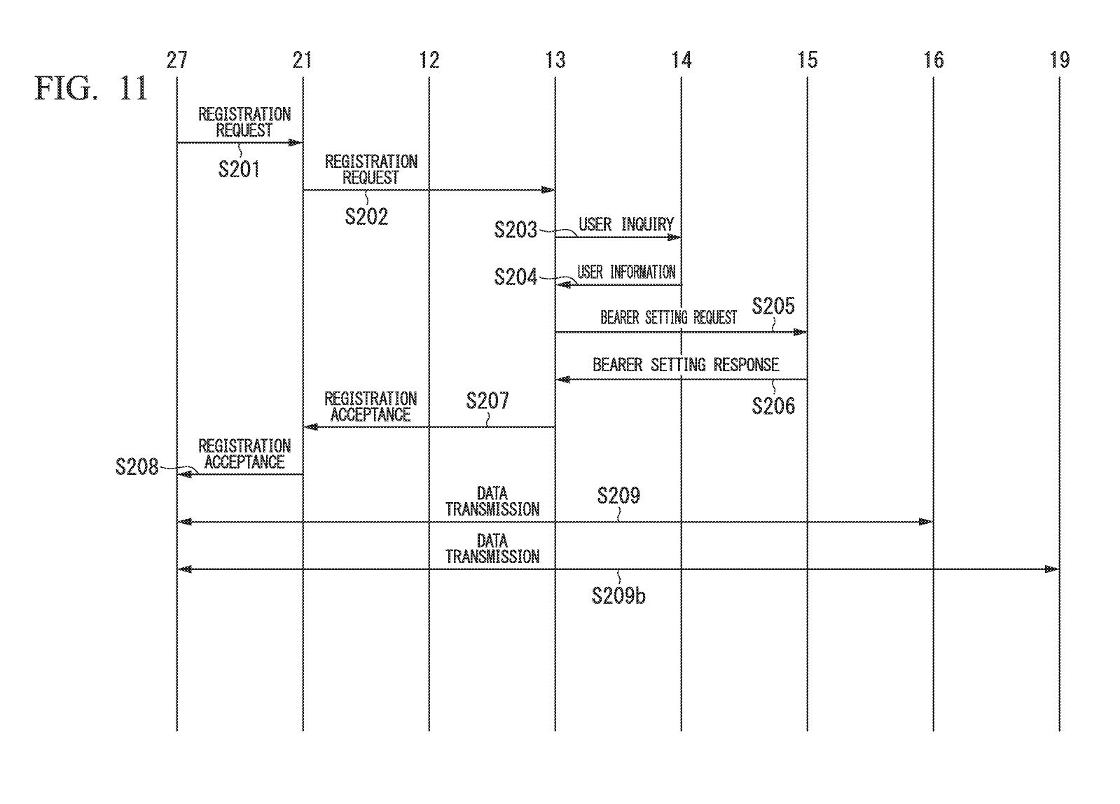

FIG. 11 is a sequence diagram showing a communication process according to the present embodiment.

The communication process described below is initiated after the communication process shown in FIG. 8 is performed in the communication system 2. The state at this starting point is such that identification information indicating the RN 21 is stored in the MME 13, and the MTC terminal device 27 can transmit and receive data via a communication path between the RN 21 and the S/P-GW 15. This state is referred to as an RN attached state.

(Step S201) The MME registration requesting unit 2734 of the MTC terminal device 27 generates a registration request signal (second registration request signal) that requests the MME 13 to register its own device (the MTC terminal device 27). The MME registration requesting unit 2734 transmits the generated registration request signal to the MME 13 (CN registration request). Then, the processing proceeds to step S202.

(Step S202) The registration processing unit 2111 of the RN 21 transmits to the MME 13, the registration request signal received from the MTC terminal device 27. The MME 13 receives the registration request signal from the RN 11. Then, the processing proceeds to step S203.

(Step S203) The MME 13 generates a user inquiry signal that inquires whether or not the user of the MTC terminal device 27 is a valid user, and transmits the generated user inquiry signal to the HSS 14. The HSS 14 receives the user inquiry signal from the MME 13. Then, the processing proceeds to step S204.

(Step S204) If it is determined that the user of the MTC terminal device 27 is a valid user, the HSS 14 generates user information indicating this determination. The HSS 14 transmits the generated user information to the MME 13. The MME 13 receives the user information from the HSS 14. Then, the processing proceeds to step S205.

(Step S205) The MME 13 generates a bearer setting request signal that requests setting of a bearer between the MTC terminal device 27 and the S/P-GW 15, and transmits the generated bearer setting request signal to the S/P-GW 15. The S/P-GW 15 receives the bearer setting request signal from the MME 13. Then, the processing proceeds to step S206.

(Step S206) The S/P-GW 15 generates bearer information indicating a bearer between the MTC terminal device 27 and the S/P-GW 15. The S/P-GW 15 transmits the generated bearer information to the MME 13 (bearer setting response). The MME 13 receives the bearer information from the S/P-GW 15. Then, the processing proceeds to step S207.

(Step S207) The MME 13 generates a registration acceptance signal including the received bearer information, and transmits the generated registration acceptance signal to the RN 21. Then, the processing proceeds to step S208.

(Step S208) The registration processing section 2111 of the RN 21 transmits to the MTC terminal device 27, the registration acceptance signal received from the MME 13 (CN registration acceptance). The MME registration request unit 2734 of the MTC terminal unit 27 retrieves the transmission source address information and the transmission destination address information from the bearer information indicated by the registration acceptance information received from the RN 21. Then, the MME registration request unit 2734 outputs the retrieved transmission source address information and transmission destination address information to the packet processing unit 2733. The retrieved transmission source address information indicates the global address information of the MTC terminal device 27. The transmission destination address information indicates the global address of the S/P-GW 15. Then, the processing proceeds to step S209.

(Step S209) The packet processing unit 2733 of the MTC terminal device 27 generates a header including the retrieved transmission source address information and the separately-obtained address information of the transmission destination device (e.g., the MTC server device 16), and adds the generated header to transmission data, thus generating a data packet. The packet processing unit 2733 transmits the generated data packet to the MTC server device 16 via the S/P-GW 15. Then, the processing ends.

Thus, in the present embodiment, the MTC terminal device 27 can transmit and receive data directly to and from a communication destination device via a public wireless network using the global address of the MTC terminal device 27 as the transmission source address information, that is, without via the MTC processing unit 211. Hereinafter, such a communication mode is referred to as a public communication mode. The public communication mode is a communication mode similar to that in a case where a normal mobile phone and a mobile terminal device perform communication using a public wireless network. Accordingly, in the public communication mode, the MTC terminal device 27 may transmit or receive data directly to and from the base station device 12 without via the RN 11 physically. In other words, the MTC terminal device 27 can directly access the base station device 12 without via the communication path between the RN 21 and the S/P-GW 15. For this reason, it is no longer bound to the processing power of the MTC processing unit 211 included in the RN 21 and the capacity of the communication path in which the MTC processing unit 211 is the transmission source or transmission destination.

Additionally, the MTC terminal device 27 may use address information of a transmission destination device connected to a network other than the MTC server 16, and transmit data to the transmission destination device. For example, the packet processing unit 2733 of the MTC terminal device 27 can transmit to the server device 19 via the S/P-GW 15, a data packet with a header including transmission destination address information of the server device 19 (see step S209b in FIG. 11).

Therefore, identification information that identifies the MTC terminal device 27 is stored the MME 13 in associated with base station identification information that identifies the base station device 12. Additionally, it is possible to logically transmit and receive data without via the MTC processing unit 211 included in the RN 11, using the global address of the MME 13 as transmission source address information. A public communication mode is a communication mode similar to that in a case where a normal mobile phone and a mobile terminal device communicate directly with each other using a public wireless network. Additionally, such a state is referred to as a CN registered state. In contrast, in the following description, as described in the first embodiment, a communication mode, in which the MTC terminal device 17 transmits and receives data to and from a communication destination device via the RN 11, using an address assigned by the RN 11 as transmission source address information, is referred to as an MTC communication mode.

As described above, in the present embodiment, the MTC terminal device 27 transmits to the RN 21, a registration request signal that requests the MME 13 to register the MTC terminal device 27 as a device to be connected to the base station device 12. The RN 21 transmits the registration request signal to the MME 13. Then, the RN 21 receives bearer information indicating a communication path between the MTC terminal device 27 and the S/P-GW 15. Then, the RN 21 transmits the received bearer information to the MTC terminal device 27. The MTC terminal device 27 transmits and receives data using the received bearer information.

Thus, the operating state of the MTC terminal device 27 enters the CN registered state through the above-described RN attached state. For this reason, each MTC terminal device 27 is prevented from simultaneously performing signaling with the MME 13. Additionally, the MTC terminal device 27 enters the CN registered state and thereby also becomes able to transmit and receive data to and from a transmission destination device other than the MTC server device 16 related to a predetermined MTC service or MTC group. Therefore, it is possible to achieve both a flexible change of the transmission destination device and a reduction in processing load on the MME 13.

### Third Embodiment

Next, a third embodiment of the present invention will be described. Hereinafter, the same reference numerals are appended to the same configurations and processes as those of the above-described embodiments, and differences will mainly be described.

A communication system 3 according to the present embodiment (not shown) has a similar configuration as that of the communication system 2 (not shown). However, the communication system 3 includes an RN 31 in lieu of the RN 21 (FIG. 9), and an MTC terminal device 37 in lieu of the MTC terminal device 27 (FIG. 10).

Next, a configuration of the RN 31 according to the present embodiment will be described.

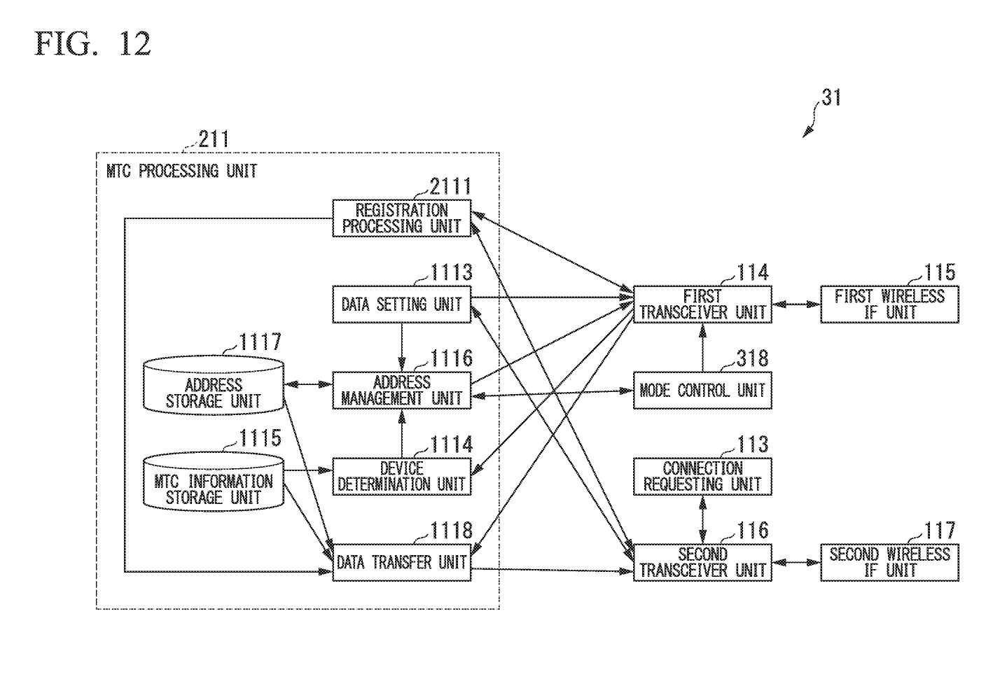

FIG. 12 is a schematic diagram showing the configuration of the RN 31 according to the present embodiment.

The RN 31 has a configuration similar to that of the RN 21, and includes a mode control unit 318.

The mode control unit 318 changes the communication mode to the public communication mode in a case where the number of MTC terminal devices performing communication in the MTC communication mode (the number of connections) exceeds a predetermined first number (maximum connection number). Additionally, the mode control unit 318 changes the communication mode to the MTC communication mode in a case where the number of connections with respect to the MTC terminal devices performing communication in the public communication mode becomes less than a predetermined second number (critical number of connections). Here, the second number is less than the first number. For example, the mode control unit 318 may randomly select an MTC terminal device to be changed in communication mode, or may select an MTC terminal device that has maintained the communication mode for the longest time so far.

Here, the mode control unit 318 generates a connection number inquiry signal that inquires the number of MTC terminal devices connected at a predetermined time interval, and outputs the generated connection number inquiry signal to the address management unit 1116.

Accordingly, when the connection number inquiry signal is received from the mode control unit 318, the address management unit 1116 counts the number of connected MTC terminal devices based on the address information stored in the address storage unit 1117. The address management unit 1116 generates a connection number signal indicating the number of counted MTC terminal devices 37, and outputs the generated connection number signal to the mode control unit 318.

The mode control unit 318 determines whether or not the number of MTC terminal devices indicated by the connection number signal received from the address management unit 1116 exceeds the predetermined first number. In a case where it is determined that the number of MTC terminal devices exceeds the first number, the mode control unit 318 generates a communication mode signal indicating the public communication mode. In a case where it is determined that the number of MTC terminal devices indicated by the connection number signal received from the address management unit 1116 is less than the predetermined second number, the mode control unit 318 generates a communication mode signal indicating the MTC communication mode.

The mode control unit 318 outputs to the first transceiver unit 114, the generated communication mode signal as a transmission signal addressed to the MTC terminal device 37 to be changed in communication mode.

Here, the mode control unit 318 may change the communication mode to the public communication mode in a case where the communication traffic of transmission or reception among MTC terminal devices performing communication in the MTC communication mode exceeds predetermined first communication traffic (maximum communication traffic). For example, the mode control unit 318 may randomly select an MTC terminal device to be changed in communication mode, or select an MTC terminal device having the largest communication traffic among the MTC terminal devices performing communication in the MTC communication mode.

Additionally, the mode control unit 318 may change the communication mode to the MTC communication mode in a case where the communication traffic with respect to MTC terminal devices performing communication in the public communication mode is less than predetermined second communication traffic (critical communication traffic). The second communication traffic is communication traffic less than the first communication traffic. For example, the mode control unit 318 may randomly select an MTC terminal device to be changed in communication mode, or select an MTC terminal device having the largest communication traffic among MTC terminal devices performing communication in the public communication mode.

Here, the mode control unit 318 generates a communication traffic inquiry signal that inquires the communication traffic of MTC terminal devices connected at a predetermined time interval, and outputs the generated communication traffic inquiry signal to the data transfer unit 1118.

Accordingly, when the communication traffic inquiry signal is received from the mode control unit 318, the data transfer unit 1118 measures the traffic per unit time (e.g., 1 second) of data received from the connected MTC terminal devices (the amount of information). The data transfer unit 1118 generates a communication traffic signal indicating the measured communication traffic, and outputs the generated communication traffic signal to the mode control unit 318.

The mode control unit 318 generates a communication mode signal indicating the public communication mode in a case where the communication traffic indicated by the communication traffic signal received from the data transfer unit 1118 exceeds the first communication traffic. The mode control unit 318 generates a communication mode signal indicating the MTC communication mode in a case where the communication traffic indicated by the communication traffic signal received from the data transfer unit 1118 is less than predetermined second communication traffic.

The mode control unit 318 outputs to the first transceiver unit 114, the generated communication mode signal as a transmission signal addressed to the MTC terminal device 37 to be changed in communication mode.

Here, for transmission of the communication mode signal, the first transceiver unit 114 may individually specify a transmission destination device using the address of the MTC terminal device 37, or simultaneously broadcast information concerning a transmission destination device to camping MTC terminal devices through a broadcast channel.

Then, a configuration of the MTC terminal device 37 according to the present embodiment will be described.

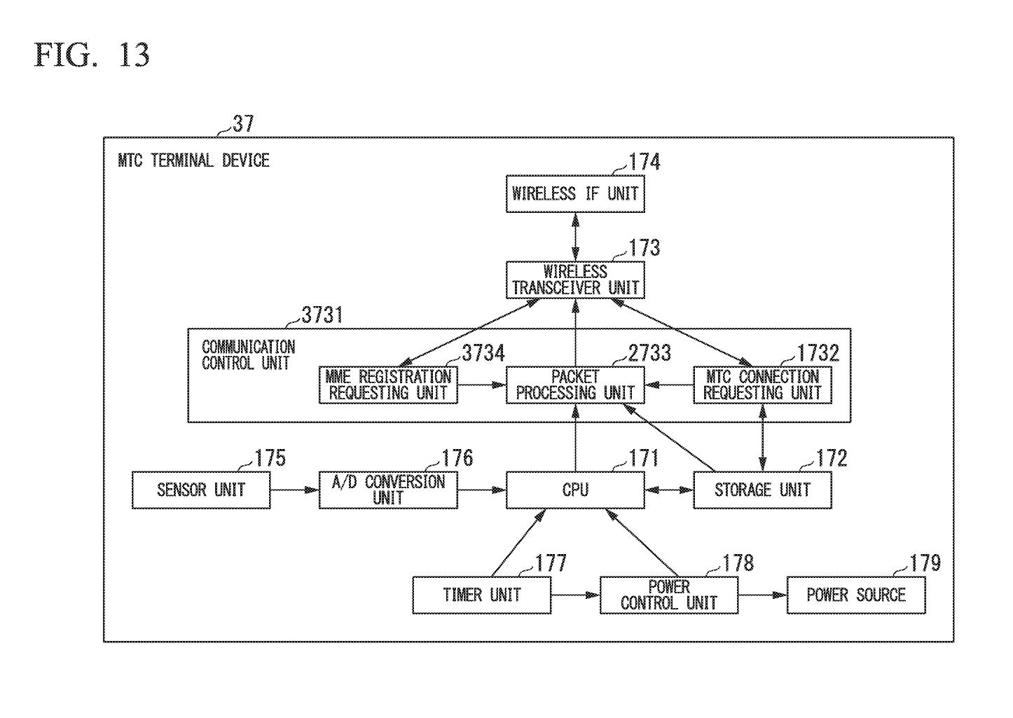

FIG. 13 is a schematic diagram showing the configuration of the MTC terminal device 37 according to the present embodiment.

The MTC terminal device 37 has a configuration similar to that of the MTC terminal device 27. However, the MTC terminal device 37 includes a communication control unit 3731 in lieu of the communication control unit 2731 (FIG. 10). The communication control unit 3731 includes an MME registration requesting unit 3734 in lieu of the MME registration requesting unit 2734 (FIG. 10).

The MME registration requesting unit 3734 has a configuration similar to that of the MME registration requesting unit 2734. However, while communication is performed in the MTC communication mode, the MME registration requesting unit 3734 receives from the wireless transceiver unit 173, a communication mode signal indicating the public communication mode (MTC release mode), as a reception signal received from the RN 11. Thereafter, the MME registration requesting unit 3734 generates a registration request signal (second registration request signal) that requests the MME 13 to register its own device (the MTC terminal device 37). The MME registration requesting unit 3734 outputs to the wireless transceiver unit 173, the generated registration request signal as a transmission signal to be transmitted to the MME 13 via the RN 11 and the base station device 12.

The MME registration requesting unit 3734 does not output a registration request signal to be transmitted to the MME 13 in a case where a communication mode signal indicating the MTC communication mode is received from the wireless transceiver unit 173, as a reception signal received from the RN 11. Here, in a case where communication has already been performed in the public communication mode, the MTC connection requesting unit 1732 generates a connection request signal, as described in the first embodiment. The MTC connection requesting unit 1732 outputs to the wireless transceiver unit 173, the generated connection request signal as a transmission signal to be transmitted to the RN 11.

For this reason, the communication mode is changed to the MTC communication mode, and the MTC terminal device 17 can transmit or receive data via the communication path between the RN 11 and the S/P-GW 15. Thus, it is possible to effectively utilize the radio resources in the public wireless communication network and avoid a waste of radio resources.

Here, in a case where a communication mode signal indicating the MTC communication mode is received from the wireless transceiver unit 173, the MME registration requesting unit 3734 may generate a deregistration signal and outputs to the wireless transceiver unit 173, the generated deregistration signal as a transmission signal to be transmitted to the MME 13. The deregistration signal is a signal that requests the MME 13 to unregister (detach) a device. After receiving the deregistration signal, the MME 13 erases the identification information of the MTC terminal device 37. Additionally, the MME 13 generates a bearer invalidation request signal that invalidates bearer information between the MTC terminal device 37 and the S/P-GW 15. The MME 13 transmits the generated bearer deactivation request signal to the S/P-GW 15. The S/P-GW 15 receives the bearer invalidation request signal and invalidates the bearer information between the MTC terminal device 37 and the S/P-GW 15. Thus, bearers, which are no longer in use, are released.

Next, a communication process according to the present embodiment will be described.

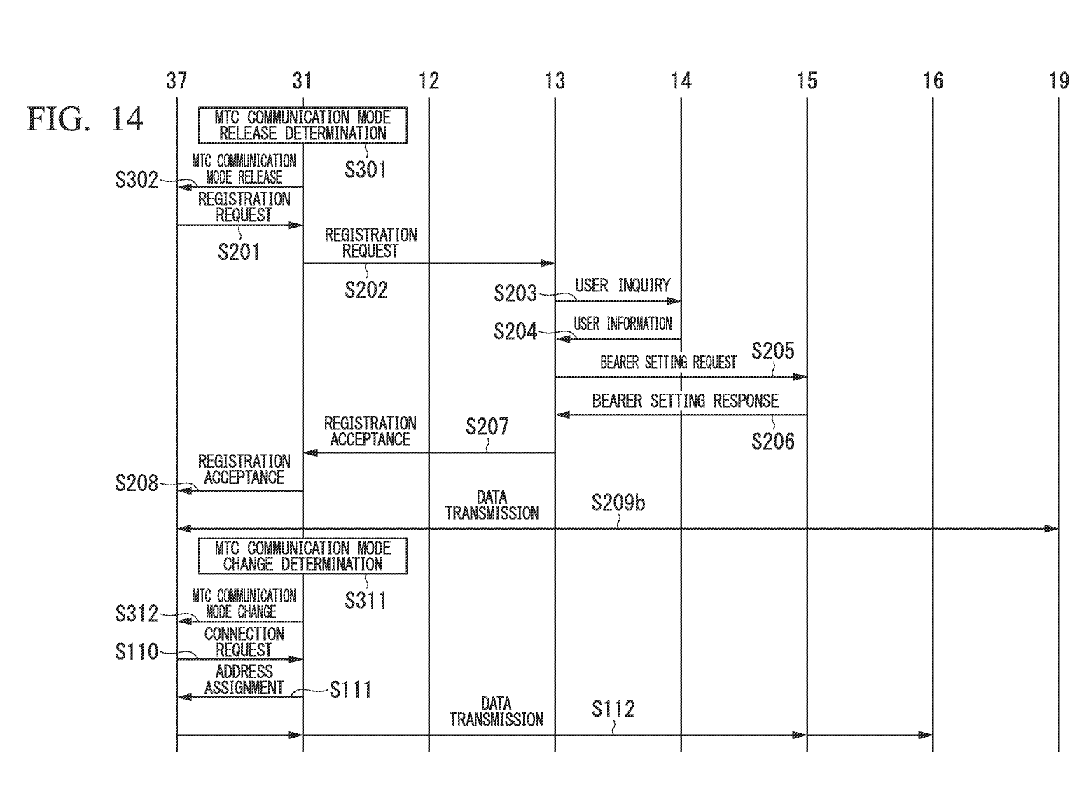

FIG. 14 is a sequence diagram showing the communication process according to the present embodiment.

The communication process to be described below is initiated after the communication process shown in FIG. 8 is performed in the communication system 3, that is, during the RN attached state.

(Step S301) The mode control unit 318 of the RN 31 inquires the address management section 1116 about the number of MTC terminal devices performing communication in the MTC communication mode. If the inquired number of MTC terminal devices exceeds a predetermined maximum number of connections, the mode control section 318 determines to change the communication mode to the public communication mode (MTC communication mode release). Then, the processing proceeds to step S302.

(Step S302) The mode control unit 318 of the RN 31 generates a communication mode signal indicating the public communication mode, and transmits the generated communication mode signal to the MTC terminal device 37 (MTC communication mode release). After the MME registration request unit 3734 of the MTC terminal device 37 receives the communication mode signal from the RN 31, steps S201 to S208 and step S209b are performed. Then, the processing proceeds to step S311.

(Step S311) The mode control unit 318 of the RN 31 inquires the address management section 1116 about the number of MTC terminal device performing communication in the MTC communication mode. If the inquired number of MTC terminal devices is below a predetermined critical number of connections, the mode control section 318 changes the communication mode to the MTC communication mode (MTC communication mode change determination). Then, the processing proceeds to step S312.

(Step S312) The mode control unit 318 of the RN 31 generates a communication mode signal indicating the MTC communication mode, and transmits the generated communication mode signal to the MTC terminal device 37 (MTC communication mode change). After receiving the communication mode signal from the RN 31, the MME registration requesting unit 3734 of the MTC terminal device 37 terminates transmission of a registration request signal addressed to the MME 13. Then, the processing proceeds to steps S110 to S112.

Here, FIG. 14 shows, as an example, a case where the necessity of a change in communication mode is determined based on the number of MTC terminal devices performing communication in the MTC communication mode. However, the necessity of a change in communication mode may be determined based on the traffic of the communication with the MTC terminal.

Additionally, in a case where the processes from step S301 are repeated without invalidating the bearer information, steps S203 to 206 may be omitted, thus omitting resetting of bearer information.

As described above, in the present embodiment, in the communication system 3, the RN 31 determines whether or not to transfer data using a communication path between the RN 31 and the S/P-GW 15, based on the number of connected MTC terminal devices 37, or the communication capacity thereof.

Thus, a clue to the determination of whether or not to use another communication path is given in accordance with processing load at the time of transferring data from the MTC terminal device 37, or the traffic of the communication via a communication path between the RN 31 and the S/P-GW 15. Thus, it is possible to avoid overload on the RN 31 and to effectively utilize the channel resources.

### Fourth Embodiment

Next, a fourth embodiment of the present invention will be described. Hereinafter, the same reference numerals will be appended to the same configurations and processes as those of the above-described embodiments, and differences will be mainly described.

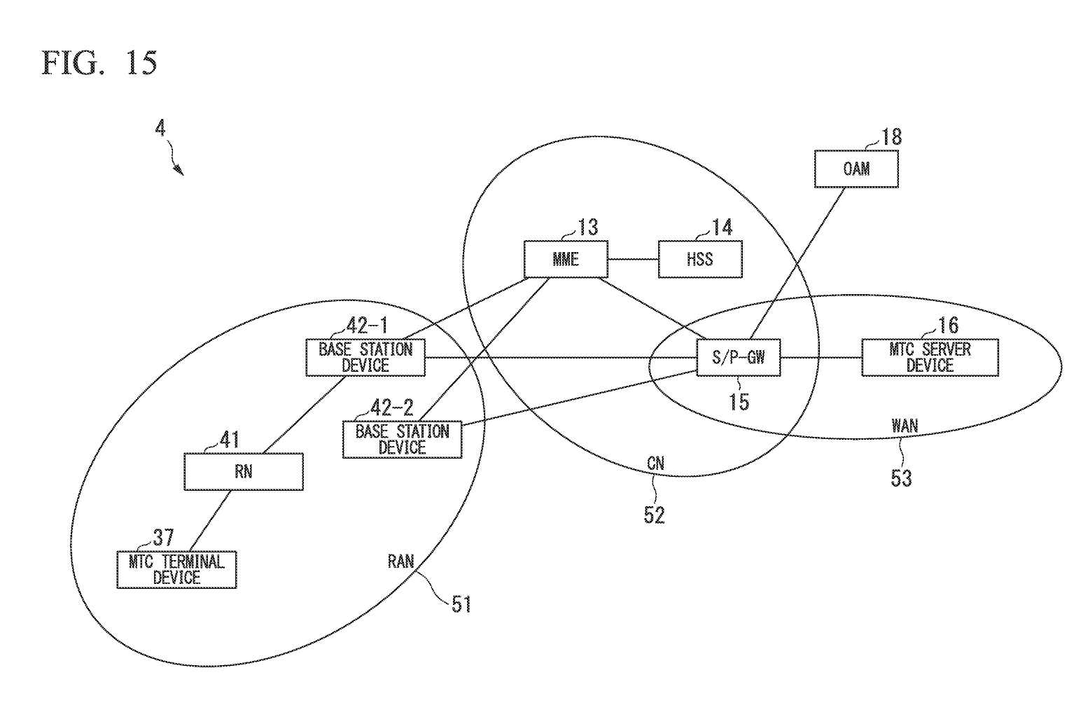

FIG. 15 is a schematic diagram showing a communication system 4 according to the present embodiment.

The communication system 4 according to the present embodiment includes an RN 41, a plurality of (for example, two) base station devices 42-1 and 42-2, the MME 13, the HSS 14, the S/P-GW 15, the MTC server device 16, an MTC terminal device 37, the OAM 18, the RAN 51, the CN 52, and the WAN 53. In other words, the communication system 4 includes the RN 41 and the base station device 42-1 in lieu of the RN 31 and the base station device 12 of the communication system 3 (not shown), respectively, and further includes the base station device 42-2.

In the following description, occasionally, the base station devices 42-1 and 42-2 will be collectively referred to as the base station device 42, the base station device 42-1, or the like.

In the present embodiment, the RAN 51 connects the MTC terminal device 37, the RN 41, and the base station devices 42-1 and 42-2.

The MME 13 previously stores base station identification informations that identify the respective base stations 42-1 and 42-2. The MME 13 stores mobile station identification information of the mobile station device registered through each base station device, in association with the base station identification information.

The S/P-GW 15 transmits or receives data packets to and from the respective base station devices 42-1 and 42-2.

Next, a configuration of the RN 41 according to the present embodiment will be described.

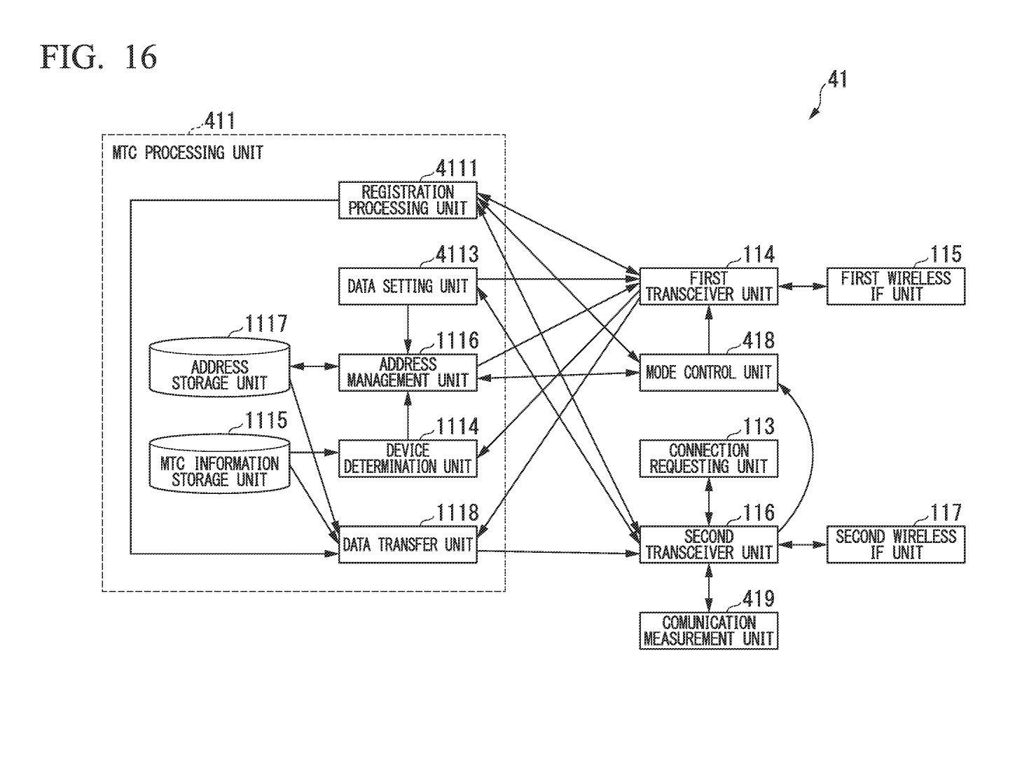

FIG. 16 is a schematic diagram showing the configuration of the RN 41 according to the present embodiment.

The RN 41 includes an MTC processing unit 411 and a mode control unit 418 in lieu of the MTC processing unit 211 and the mode control unit 318 of the RN 31 (FIG. 12), and further includes a communication measurement unit 419.

The MTC processing unit 411 includes a registration processing unit 4111 and a data setting unit 4113 in lieu of the registration processing unit 2111 and the data setting unit 1113 of the MTC processing unit 211 (FIG. 12). Hereinafter, a description will be given occasionally assuming that the base station device 42-1 (handover source) used for communication is switched to the base station device 42-2 (handover destination). Such switching of the base station device in use is referred to as handover (HO). Here, the handover source base station device and the handover destination base station device are not limited respectively to the base station devices 42-1 and 42-2, and may be any ones of the plurality of base station devices.

The registration processing unit 4111 has a configuration similar to be that of the registration processing unit 2111 (FIG. 12) and further has a configuration described next.

The registration processing unit 4111 receives from the second transceiver unit 116, a registration acceptance signal as a reception signal received from the handover destination base station device 42-2. The registration processing unit 4111 retrieves bearer information from the received registration acceptance signal, and outputs the retrieved bearer information to the data transfer unit 1118. Thus, it becomes possible to transmit or receive data between the RN 41 and a communication destination device, via the base station device 42-2 and the S/P-GW 15.

Here, the registration processing unit 4111 may generate a registration request signal after the first transceiver unit 114 receives setting parameter information from the data setting unit 4113. In this case, the registration processing unit 4111 may output to the second transceiver unit 116, the generated registration request signal as a transmission signal to be transmitted to the MME 13 via the base station device 42. Thus, the registration processing unit 4111 receives from the second transceiver unit 116, a registration acceptance signal as a reception signal received from the MME 13.

The registration processing unit 4111 generates a handover completion signal indicating that handover is complete, and outputs to the second transceiver unit 116, the generated handover completion signal as a transmission signal addressed to the handover destination base station device 42-2. Thus, the handover acceptance unit 4213 of the base station device 42-2 (which will be described later) receives the handover completion signal from the RN 41.

The registration processing unit 4111 generates a registration update request signal (tracking area update) based on mode change terminal identification information received from the mode control unit 418.

Here, the mode change terminal identification information is information indicating an MTC terminal device whose communication mode is changed from the public communication mode to the MTC communication mode at the time of handover. The registration update request signal is a signal that requests the MME 13 to update the registration of a terminal device to be changed in mode, which is indicated by the mode change terminal identification information. The registration processing unit 4111 outputs to the second transceiver unit 116, the generated registration update request signal as a transmission signal to be transmitted to the MME 13.

The registration processing unit 4111 receives from the second transceiver unit 116, a registration update acceptance signal as a reception signal received from the MME 13. The registration update acceptance signal indicates bearer information including a global address of the terminal device to be changed in mode as the transmission source address information, and a global address of the S/P-GW 15 as the transmission destination address information. The registration processing unit 4111 outputs to the first transceiver unit 114, the received registration update acceptance signal (registration update completion) as a transmission signal addressed to the terminal device to be changed in mode.

Thus, in a case where the MTC terminal device 37 is a terminal device to be changed in mode, the MME registration requesting unit 3734 retrieves bearer information from the registration update acceptance information received via the RN 11. Further, the MME registration requesting unit 3734 outputs to the packet processing unit 2733, the transmission source address information and the transmission destination address information, which are retrieved from the bearer information. Accordingly, the communication mode of the MTC terminal device 37 is changed to the public communication mode, and the MTC communication mode is released.

The registration processing unit 4111 outputs the received registration update acceptance signal to the mode control unit 418.

The data setting unit 4113 has a configuration similar to that of the data setting unit 1113 (FIG. 12) and further has a configuration described next.

When a handover instruction signal is received from the second transceiver unit 116 as a reception signal received from the base station device 42, the data setting unit 4113 generates a parameter setting request signal. The data setting unit 4113 outputs to the second transceiver unit 116, the generated setting parameter request signal as a transmission signal addressed to the OAM 18. Thus, an update of setting parameters is requested. The data setting unit 4113 receives setting parameter information from the second transceiver unit 116 as a reception signal received from the OAM 18, and outputs the received setting parameter information to the first transmitter unit 114. The first transceiver unit 114 performs a process related to transmission or reception to and from a terminal in the public communication mode, using the setting parameter information received from the data setting unit 4113.

The mode control unit 418 has a configuration similar to that of the mode control unit 318 (FIG. 12), and further has a configuration described next.

The mode control unit 418 stores in the storage unit thereof, public communication mode terminal identification information that identifies a public communication mode terminal. The public communication mode terminal means an MTC terminal device (e.g., the MTC terminal device 37) communicating with a communication destination device by the public communication mode.

The mode control unit 418 changes to the public communication mode terminal identification information, the mode change terminal identification information stored in the storage unit with respect to a mode change terminal device indicated by the registration update acceptance signal received from the registration processing unit 4111. The mode change terminal device means an MTC terminal device whose communication mode is changed from the public communication mode to the MTC communication mode.

When a handover instruction signal is received from the second transceiver unit 116 as a reception signal received from the base station device 42, the mode control unit 418 changes the communication mode of the public communication mode terminal to the MTC communication mode. Here, the mode control unit 418 generates a communication mode signal indicating the MTC communication mode, and outputs to the first transceiver unit 114, the generated communication mode signal as a transmission signal addressed to the public communication mode terminal. The mode control unit 418 changes to the mode change terminal identification information, the public communication mode terminal identification information of the public communication mode terminal whose communication mode has been changed to the MTC communication mode, and stores the mode change terminal identification information in the storage unit.

After the process related to the handover is completed, the mode control unit 418 reads the mode change terminal identification information from the storage unit thereof, and outputs the read mode change terminal identification information to the registration processing unit 4111.

The communication measurement unit 419 receives from the second transceiver unit 116, a synchronization signal as a reception signal received from the base station device 42. The communication measurement unit 419 calculates an index value representing the reception quality based on the received synchronization signal, and generates measurement information indicating the calculated index value. The communication measurement unit 419 outputs to the second transceiver unit 116, generated measurement information as a transmission signal addressed to the base station device 42 or the like.

The index value calculated by the communication measurement unit 419 is, for example, any one or any combination of SINR (signal-to-noise interference ratio), the reception power, and the like.

Next, a configuration of the base station device 42 according to the present embodiment will be described.

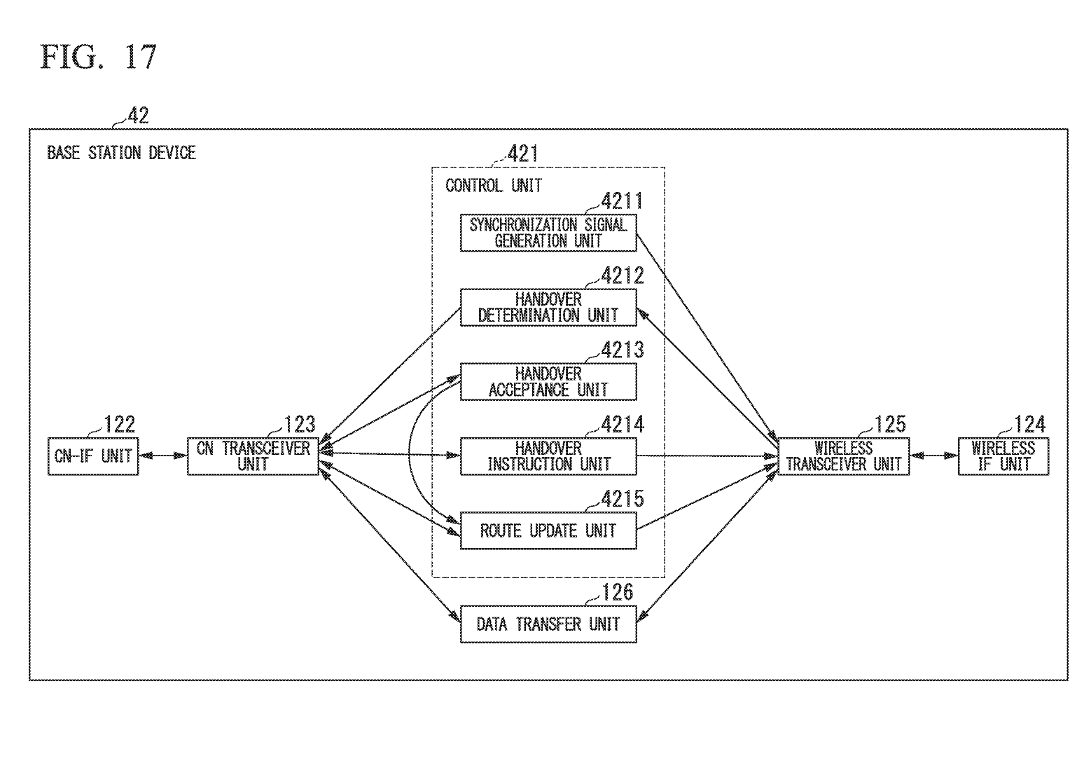

FIG. 17 is a schematic diagram showing the configuration of the base station device 42 according to the present embodiment.

The base station device 42 includes a control unit 421 in lieu of the control unit 121 of the base station device 12 (FIG. 6).

The control unit 421 includes a synchronization signal generation unit 4211, a handover determination unit 4212, a handover acceptance unit 4213, a handover instruction unit 4214, and a route update unit 4215.

The synchronization signal generation unit 4211 generates a synchronization signal indicating identification information (e.g., a cell ID) of its own device (base station device 42). The synchronization signal generation unit 4211 outputs the generated synchronization signal to the wireless transceiver unit 125 at a predetermined time interval (e.g., 10 ms), as a transmission signal addressed to the RN 41 and another terminal device in the cell.

The handover determination unit 4212 receives from the wireless transceiver unit 125, measurement information as a reception signal received from the RN 41.

Based on the measurement information received from the RN 41 and the other mobile station devices, the handover determination unit 4212 determines the necessity of handover and a handover destination base station device (e.g., the base station device 42-2). Here, the handover determination unit 4212 determines to perform handover in a case where it is determined that both the following handover conditions (1) and (2) are met: (1) the current reception quality with respect to the RN 41 and its own device is lower than the past reception quality; and (2) the current reception quality indicated by measurement information concerning another base station device (for example, the base station device 42-2) is higher than the past reception quality and is higher than the reception quality of its own device. The handover determination unit 4212 determines another base station device meeting both those conditions to be a handover destination base station device.

The handover determination unit 4212 generates a handover request signal that requests the handover destination base station device (for example, the base station device 42-2) to perform handover with respect to communication with the RN 41. The handover determination unit 4212 added to the handover request signal, identification information of the mobile station device (e.g., the RN 41) connected to the handover source base station device, and bearer identification information that identifies a bearer between that RN 41 and the S/P-GW 15.

The handover determination unit 4212 outputs to the CN transceiver unit 123, the handover request signal added with the above-described information as a transmission signal addressed to the handover destination base station device 42-2.

The handover acceptance unit 4213 determines availability of handover based on the handover request signal received from the CN transceiver unit 123 as a reception signal received from another base station device (for example, the handover source base station device 42-1). Here, the handover acceptance unit 4213 retrieves from the handover request signal, identification information of the mobile station device (e.g., the RN 41) and bearer identification information. The handover acceptance unit 4213 determines that handover is available, for example, in a case where the total communication capacity of the bearer indicated by the retrieved bearer identification information is less than the available capacity of its own device (for example, the handover destination base station device 42-2) which can be used for transmission and reception of data. The handover acceptance unit 4213 determines that handover is not available in a case where the total value is equal to or greater than the available capacity. In a case where it is determined that handover is available, the handover acceptance unit 4213 generates a handover acceptance signal indicating that determination. In a case where it is determined that handover is not available, the handover acceptance unit 4213 generates a handover acceptance signal indicating that determination.

The handover acceptance unit 4213 outputs to the CN transceiver unit 123, the generated handover acceptance signal as a transmission signal addressed to the handover source base station device 42-1. In a case where it is determined that handover is available, the handover acceptance unit 4213 outputs to the route update unit 4215, the retrieved identification information of the base station device and the bearer information.

The handover instruction unit 4214 determines whether or not a handover acceptance signal is received from the CN transceiver unit 123, as a reception signal received from another base station device 42 (for example, the handover destination base station device 42-2), within a predetermined time (for example, 90 seconds) after the handover determination unit 4212 outputs the handover request signal. In a case where the received handover acceptance signal indicates that handover is available, the handover instructing unit 4214 generates a handover instruction signal that instructs to perform handover. The handover instruction unit 4214 outputs to the wireless transceiver unit 125, the generated handover instruction signal as a transmission signal addressed to the RN 41.

The handover instruction unit 4214 outputs to the CN transceiver unit 123, the generated instruction signal as a transmission signal addressed to the other base station device 42.

In a case where the received handover acceptance signal indicates that handover is not available, or in a case where a handover acceptance signal is not received even after a predetermined time elapses, the handover instructing unit 4214 terminates the process related to the handover.

The route update unit 4215 obtains a new bearer based on the identification information of the mobile station device (e.g., the RN 41) and the bearer information which are received from the handover acceptance unit 4213. Here, the route update unit 4215 generates a registration request signal regarding the RN 41 indicated by the identification information as a transmission source device. The route update unit 4215 outputs to the CN transceiver unit 123, the generated registration request signal as a transmission signal addressed to the MME 13.

The route update unit 4215 receives a registration acceptance signal from the CN transceiver unit 123, as a reception signal received from the MME 13. The route update unit 4215 outputs to the wireless transceiver unit 125, the received registration acceptance signal as a transmission signal addressed to the RN 41.

Next, a communication process according to the present embodiment will be described. In the communication process to be described next, a case where handover is performed from the base station device 42-1 to the base station device 42-2 in the communication system 4 is illustrated.

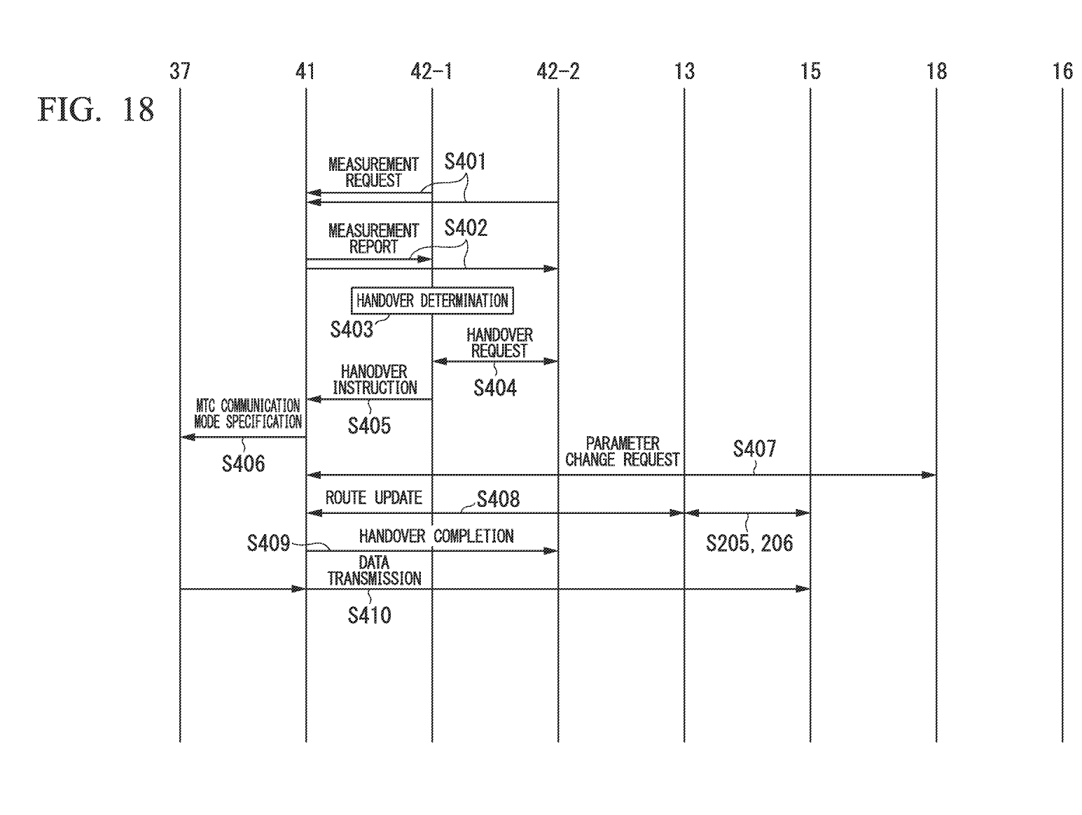

FIG. 18 is a sequence diagram showing a communication process according to the present embodiment.

(Step S401) The synchronization signal generation units 4211 of the base station device 42-1 and 42-2 transmit to the RN 41, synchronization signals generated based on the identification informations of the respective base station devices (measurement request). Then, the processing proceeds to step S402.

(Step S402) The communication measurement unit 419 of the RN 41 generates measurement information based on the synchronization signals received from the respective base station devices 42-1 and 42-2. The communication measurement unit 419 transmits the generated measurement informations to the base station devices 42-1 and 42-2 (measurement report). Then, the processing proceeds to step S403.

(Step S403) The handover determination unit 4212 of the base station device 42-1, based on the measurement information received from the RN 41, determines whether or not both the above-described handover conditions (1) and (2) are met. If it is determined that both the conditions are met, the handover determination unit 4212 determines to perform a handover to the base station device 42-2 as a handover destination device. Then, the processing proceeds to step S404.

(Step S404) The Handover determination unit 4212 of the base station device 42-1 transmits to the base station device 42-2, a generated handover request signal including identification information of the connected mobile station device and bearer identification information thereof (handover request). The handover acceptance unit 4213 of the base station device 42-2 retrieves the identification information of the mobile station device and the bearer identification information from the handover request signal received from the base station device 42-1. The handover determination unit 4212 determines the availability of handover based on the retrieved bearer identification information. If it is determined that handover is available, the handover determination unit 4212 transmits a handover acceptance signal to the base station device 42-1. Then, the processing proceeds to step S405.

(Step S405) After receiving the handover acceptance signal from the base station device 42-2, the handover instruction unit 4214 of the base station device 42-1 transmits a handover instruction signal to the RN 41. Then, the processing proceeds to step S406.

(Step S406) After receiving the handover instruction signal from the base station device 42-1, the mode control unit 418 of the RN 41 transmits the MTC terminal device 37, a communication mode signal indicating the MTC communication mode. Thus, the MTC terminal device 37 performs communication in the MTC communication mode. Then, the proceeding proceeds to step S407.

(Step S407) The data setting unit 4113 of the RN 41 transmits a setting parameter request signal to the OAM 18 (parameter change request).

The OAM 18 receives the setting parameter request signal from the RN 41, and transmits setting parameter information to the RN 11.

The first transceiver unit 114 of the RN 41 becomes able to perform a process related to transmission or reception to and from the MTC terminal device 37, using the setting parameter information received from the OAM 18. Then, the processing proceeds to step S408.

(Step S408) The route update unit 4215 of the base station device 42-2 generates a registration request signal based on the identification information received from the handover acceptance unit 4213, and transmits the generated registration request signal to the MME 13.

The MME 13 performs steps S205 and S206 (FIG. 11) based on the registration request signal received from the base station device 42-2, and transmits a registration acceptance signal to the base station device 42-2. The route update unit 4215 of the base station device 42-2 transmits to the RN 41, the registration acceptance signal received from the MME 13 (route update).

The registration processing unit 4111 of the RN 41 outputs to the data transfer unit 1118, the bearer information retrieved from the registration acceptance signal received from the base station device 42-2. Then, the processing proceeds to step S409.

(Step S409) The registration processing unit 4111 of the RN 41 transmits a handover completion signal to the base station device 42-2. Then, the processing proceeds to step S410.

(Step S410) The data transfer unit 1118 of the RN 41 replaces the transmission destination address information of the data packet received from the MTC terminal device 37 with the transmission destination address read from the address storage unit 1117. The data transfer unit 1118 generates a tunnel header including the transmission source address information and the transmission destination address information which are indicated by the bearer information received from the registration processing unit 4111. The data transfer unit 1118 adds the generated tunnel header to the data packet with the replaced transmission destination address, thus generating a new data packet. Thus, the data transfer unit 1118 transmits the generated data packet to the MTC server device 16 via the S/P-GW 15. Thus, the RN 41 transmits the data received from the MTC terminal device 37, to the MTC server device 16 physically via the base station device 42-2 and the S/P-GW 15. Then, the processing ends.

Next, a modified example of the communication process according to the present embodiment will be described. The present modified example relates to a process of changing the communication mode from the MTC communication mode to the public communication mode after handover is complete. This process is performed with respect to a mode change terminal (e.g., the MTC terminal device 37) that has been performing communication in the public communication mode before handover is performed.

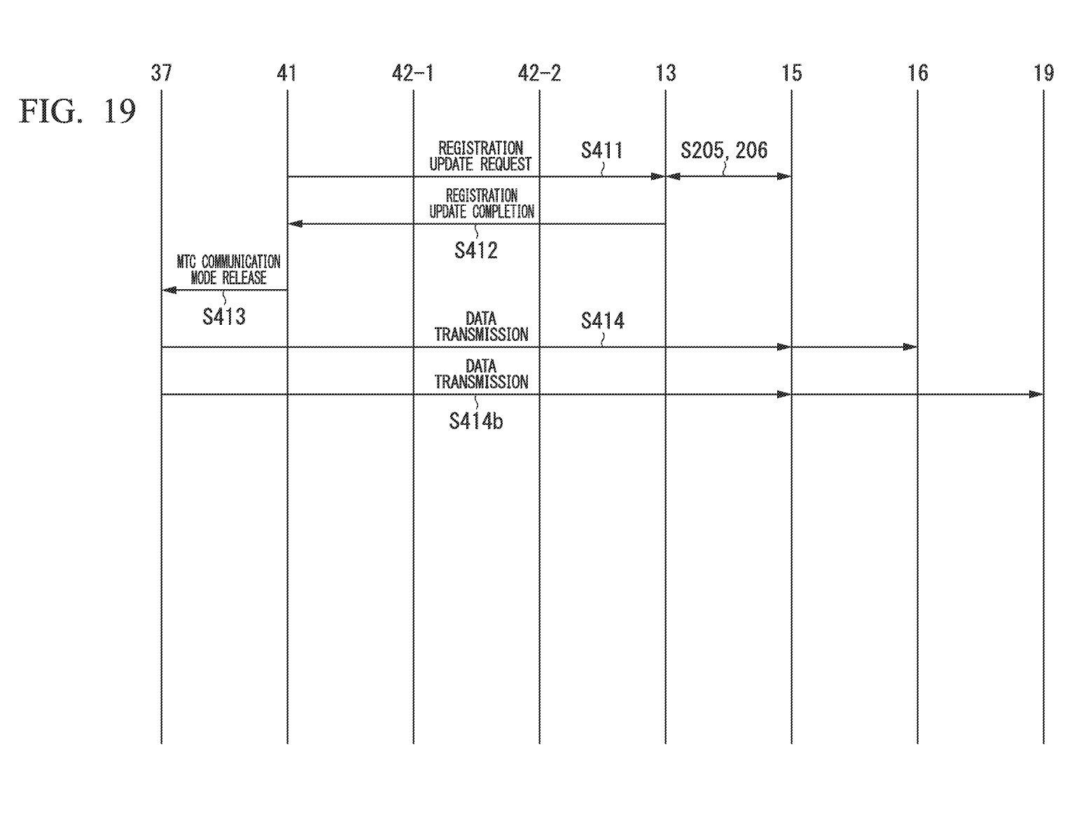

FIG. 19 is a sequence diagram showing the modified example of the communication process according to the present embodiment.

(Step S411) The registration processing unit 4111 of the RN 41 generates a registration update request signal based on the mode change terminal identification information received from the mode control unit 418. The registration processing unit 4111 transmits the generated registration update request signal to the MME 13.

The MME 13 stores the identification information of the RN 41 indicated by the received registration update request signal and the identification information of the base station device 42-2, while associating those informations with each other. Additionally, the MME 13 performs steps S205 and S206 to obtain bearer information. Then, the processing proceeds to step S412.

(Step S412) The MME 13 generates a registration update acceptance signal including the obtained bearer information, and transmits the generated registration update acceptance signal to the RN 41.

The registration processing unit 4111 of the RN 41 transmits to the MTC terminal device 37, the registration update acceptance signal received from the MME 13. The MME registration requesting unit 3734 of the MTC terminal device 37 receives the registration update acceptance signal from the RN 41. Then, the processing proceeds to step S413.

(Step S413) The mode control unit 418 of the RN 41 generates a communication mode signal indicating the public communication mode, and transmits the generated communication mode signal to the MTC terminal device 37 (MTC communication mode release). The MME registration requesting unit 3734 of the MTC terminal device 37 retrieves the transmission source address information and the transmission destination address information from the bearer information, and outputs the retrieved informations to the packet processing unit 2733. Then, the processing proceeds to step S414.

(Step S414) The packet processing unit 2733 of the MTC terminal device 37 generates a header and a tunnel header based on the transmission source address information and the transmission destination address information which are received from the MME registration requesting unit 3734. The packet processing unit 2733 adds the generated header and tunnel header to a transmission data, thus generating a tunnel data packet. The packet processing unit 2733 transmits the generated tunnel data packet to the MTC server device 16 via the S/P-GW 15. Thus, data is transmitted from the MTC terminal device 37 to the MTC server 16. Then, the processing ends.

Here, similarly to step S209b (FIG. 11), the MTC terminal device 37 may use address information of a transmission destination device (e.g., the server device 19) connected to a network other than the MTC server device 16, to transmit data to the transmission destination device (step S414b in FIG. 19).

As described above, in the present embodiment, when the connected base station device 42-1 is changed to another base station device 42-2 in the communication system 4, the RN 41 determines to transfer data using a communication path between the RN 41 and the S/P-GW 15. Thus, it is possible to limit, before the change of the base station device, a communication path to be used for transmission and reception of data to and from the MTC terminal device 37, to the communication path between the RN 41 and the S/P-GW 15. Therefore, it is possible to limit, during the change of the base station device, the communication traffic related to the signaling between the MME 13 and the MTC terminal device 37 or another device.

Here, in each embodiment described above, the RNs 11, 21, 31, and 41 may be configured to transmit and receive data to and from another mobile station device in addition to the MTC terminal devices 17, 27 and 37. Here, whether or not the RNs 11, 21, 31, and 41 perform transmission and reception of data to and from another mobile station device, and a ratio of communication traffic of transmission and reception to and from another mobile station device, may be variable. For example, the RNs 11, 21, 31, and 41 may be configured not to perform transmission and reception to and from another mobile station device in a case where the communication traffic of the data transmitted and received to and from the MTC terminal devices 17, 27 and 37 is greater than a predetermined communication traffic. Further, the RNs 11, 21, 31, and 41 may be configured to, as the communication traffic of the transmission and reception of data to and from the MTC terminal devices 17, 27, and 37 increases, reduce allowable communication traffic of transmission and reception to and from another mobile station device.

The description has been given above while taking an example the case where data is transmitted from the MTC terminal device 17, 27, and 37 to the MTC server device 16. However, each embodiment described above is not limited thereto. In each embodiment described above, the MTC server device 16 may be configured to transmit data to the MTC terminal devices 17, 27, and 37.

In each embodiment described above, a common communication scheme (e.g., LTE (long term evolution), etc.) may be used among the MTC terminal devices 17, 27, and 37, the RNs 11, 21, 31 and 41, and the base station devices 12 and 42. Additionally, different communication schemes may be used among the MTC terminal devices 17, 27, and 37, and the RNs 11, 21, 31 and 41, and among the RNs 11, 21, 31 and 41, and the base station devices 12 and 42. For example, a scheme such as LTE, which is used in the public wireless network, is used among the RNs 11, 21, 31 and 41, and the base station devices 12 and 42. In contrast, a scheme such as IEEE.802.15.1, which is used in a short-range wireless communication network, may be used among the MTC terminal devices 17, 27, and 37, and the RNs 11, 21, 31 and 41.

In a case where the number of MTC terminal devices 37 connected to its own device (the RN 31 or 41) or the communication traffic thereof is less than a predetermined value, the mode control unit 318 and 418 may change the communication mode to the public communication mode. In a case where the MTC processing units 211 and 411 are supplied with power independently of the other functional units, the power supply may be terminated after the communication mode is changed to the public communication mode. Thus, it is possible to reduce power consumption.

Here, the description has been given above while taking as an example the case where the mode control units 318 and 418 determine an operation mode based on the number of MTC terminal devices 37 connected to its own device (the RN 31 or 41) and the communication traffic thereof. However, the present embodiment is not limited thereto. The mode control units 318 and 418 may determine an operation mode based on communication traffic and propagation characteristics between its own device (the RN 31 or 41) and the base station device 12 or 42, processing load on the MME 13 and another device connected to the CN 52, and communication traffic of the CN 52.

A channel to be used for communication among the RNs 11, 21, 31, and 41, and the base station device 12 and 42 is not limited to a wireless channel, and a wired channel may be used. For example, the RNs 11, 21, 31, and 41 may be remote radio equipments (RRE), and both a wireless channel and a wired channel may be used.

In a case where the RNs 11, 21, 31, and 41 use both a wireless channel and a wired channel, for example, for a purpose of maintenance or the like, one of the wireless channel and the wired channel (for example, the wired channel) is disconnected and reconnected later in some cases. In this case, similarly to the fourth embodiment described above, the RN 41 may be configured to, before any one channel is disconnected, perform step S406 (FIG. 18) on the MTC terminal device 37 connected to the channel to be disconnected. Then, the RN 41 may be configured to perform steps S411 to S414 (FIG. 18) after the disconnected channel is reconnected. Thus, the communication is continued using the continuously-connected channel. Further, the RN 41 may include a storage unit configured to store data received from a transmission source device while the channel is disconnected, and after the channel is reconnected, the RN 41 may transmit the data stored in the storage unit. Thus, data can be reliably transmitted and received even if a channel is temporarily disconnected.

Here, a computer may implement part of the RNs 11, 21, 31, and 41 or part of the MTC terminal devices 17, 27, and 37, for example, the MTC processing units 111, 211, and 411, the mode control units 318 and 418, the communication measurement unit 419, and the communication processing units 1731, 2731, and 3731. In this case, a program for implementing those control functions may be recorded on a computer-readable recording medium, so that a computer system can read and execute the program recorded on the recording medium to implement the control functions. Here, the “computer system” means computer systems included in the RNs 11, 21, 31, and 41 or the MTC terminal devices 17, 27, and 37. Additionally, the “computer system” may include an OS and hardware such as peripheral devices. Further, the “computer-readable recording medium” means a storage device, such as: a portable medium, for example, a flexible disk, a magneto optical disk, a ROM, or a CD-ROM; or a hard disk built in a computer system.

Moreover, the “computer-readable recording medium” may also include a medium that dynamically stores a program for a short period, such as a communication line in a case where the program is transmitted via a network such as the Internet, or a communication line such as a telephone line. Moreover, the “computer-readable recording medium” may also include a medium that temporarily stores a program, such as a volatile memory included in a computer system which serves as a server or client in the above case. Additionally, the above program may be a program for implementing part of the above-described functions. Further, the above program may be a program that can implement the above-described functions in combination with the program already stored in the computer system.

Additionally, part or whole of the RNs 11, 21, 31, and 41 or the MTC terminal devices 17, 27, and 37 of the above-described embodiments may be implemented as an integrated circuit, such as an LSI (large scale integration). Each functional block of the RNs 11, 21, 31, and 41 or the MTC terminal devices 17, 27, and 37 may be individually made into a chip. Alternatively, part or whole of the functional blocks may be integrated and made into a chip. Additionally, the method of forming an integrated circuit is not limited to LSI, and an integrated circuit may be implemented by a dedicated circuit or a general-purpose processor. Further, if technology of forming an integrated circuit, which replaces LSI, arises as a result of advances in semiconductor technology, an integrated circuit formed by that technology may be used.

As described above, one embodiment of the present invention has been described in detail with reference to the drawings, a specific configuration is not limited to those described above, and various design modifications may be made without departing from the scope of the invention.

### INDUSTRIAL APPLICABILITY

The present invention is applicable to a relay device that reduces the load on the MME, a wireless terminal device, and a communication system and a communication method.

### DESCRIPTION OF REFERENCE NUMERALS

1, 2, 3, 4: communication system
11, 21, 31, 41, . . . , RN, 111, 211, 411: MTC processing unit
1111, 2111, 4111: registration processing unit
1113, 4113: data setting unit
1114: device determination unit
1115: MTC information storage unit
1116: address management unit:
1117: address storage unit
1118: data transfer unit
113: connection requesting unit
114: first transceiver unit
115: first wireless IF unit
116: second transceiver unit
117: second wireless IF unit
318, 418: mode control unit
419: communication measurement unit
12, 42 (42-1, 42-2): base station device
121, 421: control unit
4211: synchronization signal generator
4212: handover determination unit
4213: handover acceptance unit
4214: handover instruction unit
4215: route update unit
122: CN-IF unit
123: CN transceiver unit
124: wireless IF unit
125: wireless transceiver unit
126: data transfer unit
13: MME
14: HSS
15: S/P-GW
16: MTC server device
17, 27, 37: MTC terminal device
171: CPU
172: storage unit
173: wireless transceiver unit
1731, 2731, 3731: communication processing unit
1732: MTC connection requesting unit
1733, 2733: packet processing unit
2734, 3734: MME registration requesting unit
174: wireless IF unit
175: sensor unit
176: A/D conversion unit
177: timer unit
178: power control unit
179: power source
18: OAM
51: RAN
52: CN
53: WAN

1. A relay device comprising:
a registration processing unit configured to
transmit to a mobile management device, a first registration request signal that requests registration of the relay device, and
receive first communication path information indicating a communication path between the relay device and a gateway device;
a device determination unit configured to
receive a connection request signal that requests connection, from a wireless terminal device related to a predetermined group or service, and
determine based on the connection request signal whether or not to transfer data related to the wireless terminal device; and
a data transfer unit configured to transfer the data related to the wireless terminal device using the communication path indicated by the first communication path information.

2. The relay device according to claim 1, wherein the registration processing unit is configured to
transmit to the mobile management device, a second registration request signal that requests registration of the wireless terminal device,
receive a second communication path information indicating a communication path between the wireless terminal device and the gateway device, and
transmit the second communication path information to the wireless terminal device.

3. The relay device according to claim 2, wherein the registration processing unit is configured to
receive from the wireless terminal device, a registration request signal that requests registration of the wireless terminal device, and
transmit the received registration request signal as the second registration request signal.

4. The relay device according to claim 3, further comprising:
a mode determination unit configured to determine whether to transfer data using the communication path indicated by the first communication path information or the communication path indicated by the second communication path information.

5. The relay device according to claim 4, wherein the mode determination unit is configured to, in a case that a base station device connected to the relay device is changed to another base station device, determine to transfer data using the communication path indicated by the first communication path information.

6. The relay device according to claim 4, further comprising:
a mode control unit configured to, in a case that it is determined to transfer data using the communication path indicated by the first communication path information, transmit to the wireless terminal device, a communication mode signal indicating that data is to be transferred using the communication path.

7. The relay device according to claim 5, wherein the registration processing unit is configured to, after the base station device connected to the relay device is changed to the other base station device, transmit to the mobile management device, a second registration request signal that requests registration of the wireless terminal device.

8. The relay device according to claim 1, further comprising:
an address management unit configured to assign different addresses to the wireless terminal devices.

9. A wireless terminal device comprising:
a communication control unit configured to
transmit to a relay device, a connection request signal that requests connection between the relay device and the wireless terminal device related to a predetermined service or group, and
receive an address generated by the relay device; and
a transceiver unit configured to transmit and receive, using the received address, data to and from a communication destination device related to the service or group, via a first communication path between the relay device and a gateway device.

10. The wireless terminal device according to claim 9, wherein the communication control unit is configured to transmit a registration request signal that requests registration of the wireless terminal device, and
the communication control unit is configured not to transmit the registration request signal in a case that a communication mode signal is received from the relay device, the communication mode signal indicating that data is to be transferred using a communication path between the relay device and a gateway device, and the communication path being indicated by first communication path information.

11. A communication system comprising:
a wireless terminal device related to a predetermined service or group;
a relay device;
a base station device to be connected to the relay device;
a gateway device; and
a mobile management device,
wherein the relay device comprises:
a registration processing unit configured to
transmit to the mobile management device, a first registration request signal that requests registration of the relay device, and
receive first communication path information indicating a communication path between the relay device and the gateway device;
a device determination unit configured to
receive from the wireless terminal device, a connection request signal that requests connection, and
determine based on the connection request signal whether or not to transfer data related to the wireless terminal device; and
a data transfer unit configured to transfer the data using the communication path indicated by the first communication path information.

12. The communication system according to claim 11, wherein the registration processing unit is configured to
transmit to the mobile management device, a second registration request signal that requests registration of the wireless terminal device, and
receive second communication path information indicating a communication path between the wireless communication device and the gateway device, and
wherein the relay device further comprises:
a mode determination unit configured to determine whether to transfer data using the communication path indicated by the first communication path information or the communication path indicated by the second communication path information, the mode determination unit being configured to, in a case that a base station device connected to the relay device is changed to another base station device, determine to transfer data using the communication path indicated by the first communication path information.

13. A communication method for a communication system comprising a wireless terminal device related to a predetermined service or group, a relay device, a base station device to be connected to the relay device, a gateway device, and a mobile management device, the communication method comprising:
a first step for the relay device to
transmit to the mobile management device, a first registration request signal that requests registration of the relay device, and
receive first communication path information indicating a communication path between the relay device and the gateway device;
a second step for the relay device to
receive from the wireless terminal device, a connection request signal that requests connection, and
determine based on the connection request signal whether or not to transfer data related to the wireless terminal device; and
a third step for the relay device to transfer the data using the communication path indicated by the first communication path information.
